(19) United States
(12) Patent Application Publication
(10) Pub. No.: US 2011/0058110 A1
(43) Pub. Date: Mar. 10, 2011

(54) DISPLAY DEVICE AND TELEVISION RECEIVER

(76) Inventors: Naoshi Yamada, Osaka (JP); Toshihide Tsubata, Osaka (JP)

(21) Appl. No.: 12/990,872

(22) PCT Filed: Feb. 17, 2009
(86) PCT No.: PCT/JP2009/052643

§ 371 Date: Nov. 3, 2010

(30) Foreign Application Priority Data
May 13, 2008 (JP) 2008-126230

(51) Int. Cl. H04N 3/14

(52) U.S. Cl. 348/790; 348/E03.016

(57) ABSTRACT

A display device 10 of the present invention includes a plurality of gate signal lines 45, a plurality of data signal lines 43, pixel electrodes 41, hold capacitor lines 46 and a common electrode 36. The data signal lines 43 extend in a direction that crosses the gate signal lines 45. Each pixel electrode 41 is surrounded by the gate signal lines 45 and the gate signal lines 43. The hold capacitor lines 46 are configured such that hold capacitances appear between the pixel electrodes 41 and the hold capacitor lines 46. The common electrode 36 is arranged so as to face the pixel electrodes 41. Conductive parts 48 are provided on the gate signal lines 45 or the hold capacitor lines 46 between the adjacent pixel electrodes 41, 41. The conductive parts 48 are electrically isolated from the pixel electrodes 41 and electrically connected to at least one of the gate lines 45, the hold capacitor lines 46 and the common electrode 36.

### TECHNICAL FIELD

The present invention relates to a display device and a television receiver.

### BACKGROUND ART

A liquid crystal display device including a plurality of gate signal lines and a plurality of data signal lines arranged in a grid, and pixel electrodes arranged such that each of them is surrounded by those signal lines is known as an active-matrix liquid crystal display device. Data signals are fed to the pixel electrodes via switching components. In such a liquid crystal display device, liquid crystal components are deteriorated due to electrochemical reaction that occurs when a DC voltage is applied. AC drive (hereinafter also referred to as inversion drive) that periodically inverts a voltage polarity of application voltage of the data signal is preferable to drive the liquid crystal display device over a long period of time.

If the voltage polarity is inverted for every frame in the active-matrix liquid crystal display device, potentials at pixels vary due to an anisotropy in dielectric permittivity of liquid crystals or a parasitic capacitance that may exit between the gate signal lines and the data signal lines. As a result, brightness varies and thus uneveness or flicker may be seen on screen. To solve such a problem, various inversion drive methods are considered. In one of the methods, gate signal lines are divided into the first group and the second group. All gate signal lines all gate signal lines in the first group are selected and then all gate signals in the second group are selected. A signal voltage with the first polarity is applied to the data signal lines while the first group is selected. Then, a signal voltage with the second voltage polarity, which is different from the first voltage polarity, is applied to the data signal lines while the second group is selected.

Patent Document 1: Japanese Published Patent Application No. H11-352938

### Problem to be Solved by the Invention

However, the uneveness on screen cannot be prevented even with the drive method disclosed in Patent Document 1. One of the reasons is an influence of parasitic capacitance that exists between adjacent pixel electrodes. The pixel electrodes between which the parasitic capacitance exists electrically influence each other due to the parasitic capacitance. As a result, an unwanted voltage variation occurs. For instance, to drive the liquid crystal display device as disclosed in Patent Document 1, the voltage polarity of data signals is inverted for each group of the gate signal lines. If the parasitic capacitance exists between the pixel electrodes, the voltage at the pixel electrodes in one of the groups located near the border between two groups may increase or decrease according to the voltage polarity inversion. Such voltage variation affects the brightness of display images and may cause display uneveness.

### DISCLOSURE OF THE PRESENT INVENTION

The present invention was made in view of the foregoing circumstances. An object of the present invention is to provide a display device with high display quality in which display uneveness is less likely to occur. Another object of the present invention is to provide a television receiver including such a display device.

### Means for Solving the Problem

To solve the above problem, a display device of the present invention includes a plurality of gate signal lines, a plurality of data signal lines, switching components, pixel electrodes, hold capacitor lines and a common electrode. Gate signal lines are fed to the gate signal lines. The data signal lines extend in a direction that crosses the gate signal lines and data signals are fed thereto. The switching components are arranged around intersections of the gate signal lines and the data signal lines. The pixel electrodes are connected to the switching components. The hold capacitor lines are configured such that hold capacitances appear between the pixel electrodes and the hold capacitor lines. The common electrode is arranged so as to face the pixel electrodes and configured such that a voltage can be applied across the pixel electrodes and the common electrode. Conductive parts are provided between the pixel electrodes adjacent to each other. The conductive parts are electrically isolated from the pixel electrodes and electrically connected to at least one of the gate lines, the hold capacitor lines and the common electrode.

With this configuration, the conductive parts on the gate signal lines or the hold capacitor lines between the adjacent pixel electrodes function as shield electrodes that can compensate for a parasitic capacitance between the pixel electrodes. Therefore, unwanted voltage variations at the pixel electrodes are less likely to occur.

In this display device, predetermined voltages are applied to the pixel electrodes via the switching components according to the gate signals and the data signals. When the voltage is applied to the pixel electrodes, the parasitic capacitance may appear between the adjacent pixel electrodes. The pixel electrodes between which the parasitic capacitance exists may electrically influence each other and unwanted voltage variations may occur. For example, when the display device s driven by inverting the voltage polarity of the data signals with respect to a reference voltage for every line or pixel, the voltage at one of the pixel electrodes may increase or decrease according to the inversion of the voltage polarity if the parasitic capacitance exists between the pixel electrodes. Such a voltage variation affects the brightness of the display images and thus display uneveness may occur.

To reduce the voltage variation, the conductive parts are provided between the adjacent pixel electrodes in the display device of the present invention. As a result, the parasitic capacitance is less likely to appear between the pixel electrodes. Specifically, the conductive parts are electrically isolated from the pixel electrodes and electrically connected to at least one of the gate lines, hold capacitor lines and the common electrode. Therefore, the capacitance is less likely to appear between the pixel electrodes can be compensated with any one of the gate lines, the hold capacitor lines and the common electrodes. As a result, the parasitic capacitance is less likely to appear between the adjacent pixel electrodes and thus the unwanted voltage variations are less likely to occur at the pixel electrodes. Therefore, the display uneveness is less likely to occur and high display quality can be achieved.

In the display device of the present invention, the gate signal lines are grouped into a plurality of blocks, each of which includes at least two gate signal lines. Voltage polarities of the data signals with respect to a reference voltage in the adjacent blocks differ from one another.

The gate signal lines are grouped into a plurality of blocks, each of which includes at least two gate signal lines. The switching components in each block are connected to the gate signal line and the data signals are fed during time that the switching components are turned on. The voltage polarities of the data signals with respect to the reference voltage are different between the adjacent blocks.

In this case, the voltage polarity of the first data signal fed to the second block may be altered (or inverted) from that of the last data signal fed to the first block. When the writing to the pixels in the first block is complete, the data signal with an inverted voltage polarity is fed to the second block. If the parasitic capacitance exists between the pixel electrodes, the voltage at the pixel electrode adjacent to the second block in the first block may be varied due to an influence of the voltage with different polarity in the second block. As a result, the varied voltage at the pixel differs from the voltage at the peripheral pixels. This may cause display uneveness. Especially, uneveness that appears as a streak between blocks is more likely to occur.

In the above configuration of driving, the parasitic capacitances are less likely to appear between the pixel electrodes because of the conductive part between the adjacent pixel electrodes according to the configuration of the present invention. Even when the voltage polarity of the data signals is varied from one block to another, an unwanted voltage variation at each pixel is less likely to occur. This produces an effect to reduce the occurrence of uneveness.

In the display device of the present invention, the gate signal lines are grouped into a plurality of blocks, each of which includes at least two gate signal lines. The gate signal lines in each block are configured to be scanned in any one of manners that the gate signal lines on odd lines are scanned after the gate signal lines on even lines are scanned and the gate signal lines on even lines are scanned after the gate signal lines on odd lines are scanned. The voltage polarity of the data signals fed to the gate signal lines on the even lines with respect to a reference voltage is different from a voltage polarity of the data signals fed to the gate signal lines on the odd lines with respect to the reference voltage.

The gate signal lines are grouped into a plurality of blocks, each of which includes at least two gate signal lines. The gate signal lines in each block are configured to be scanned in any one of manners that the gate signal lines on odd lines are scanned after the gate signal lines on even lines are scanned and the gate signal lines on even lines are scanned after the gate signal lines on odd lines are scanned. The voltage polarity of the data signals fed during time that the switching components connected to the gate signal lines on the even lines are turned of differs from that of the data signals fed during time that the switching components connected to the gate signal lines on the odd lines are turned on.

In this case, the voltage polarity of the data signals may be altered (or inverted) when the data signals are switched between the ones that correspond to the gate signal lines on the even lines and the ones that correspond to the gate signal lines on the odd lines. When the writing to the pixels that correspond to the gate signal lines on the even lines, which are scanned earlier, is complete, the data signals with the inverted voltage polarity are applied to the pixels that correspond to the gate signal lines on the odd lines. If the parasitic capacitance exists between the pixel electrodes, the voltage at the pixel electrodes that correspond to the gate signal lines on the even lines may be varied due to the voltage polarity of the voltage applied to the pixel electrodes that correspond to the gate signal lines on the odd lines. The similar voltage variation may occur at the pixel electrodes in the block, the writing to which is complete earlier among the blocks that include a plurality of the gate signal lines. As a result, the voltages of the pixels at which the voltages are varied differ from that of the peripheral pixels and thus display uneveness may occur. Especially, uneveness that appears as a streak between blocks is more likely to occur.

In the above configuration of driving the parasitic capacitances are less likely to appear between the pixel electrodes because of the conductive part between the adjacent pixel electrodes according to the configuration of the present invention. Even when the voltage polarity of the data signals is varied between odd lines and even lines or between the blocks, an unwanted voltage variation at each pixel is less likely to occur. This produces an effect to reduce the occurrence of uneveness.

Furthermore, an interlayer insulator is provided between the pixel electrodes and the gate signal lines or the data signal lines so as to provide electrical isolation between them. The interlayer insulator includes a first interlayer insulator and a second interlayer insulator layered in this order from the gate signal lines side or the data signal line side. The second interlayer insulator has a larger thickness than the first interlayer insulator.

According to such a configuration including the double-layered insulator having the first interlayer insulator and the second interlayer insulator, the parasitic capacitances are less likely to appear between the pixel electrodes and the gate signal lines or the data signal lines. Namely, influences of the voltages at the pixel electrodes on levels of the gate signal waveforms or the data signal waveforms, which may decrease the levels, can be reduced. On the other hand, the parasitic capacitances are more likely to appear between the adjacent pixel electrodes. This is because the parasitic capacitances are less likely to appear between the pixel electrodes and the gate signal lines or the data signal lines due to the double-layered insulator having a large thickness and thus the number of components that generate electric fields together with pixel electrodes decreases. The interlayer insulator having a large thickness can restrict the appearance of the parasitic capacitances between the pixel electrodes and the gate signal lines or the data signal lines when areas (or an aperture ratio) of the pixel electrodes are increased by overlapping the pixel electrodes with the gate signal lines or the data signal lines. However, the parasitic capacitances are likely to appear between the pixel electrodes and the gate signal lines or the data signal lines because the adjacent pixel electrodes are more closely located to each other.

According to the configuration of the present invention in such a configuration having electrical insulation between the gate signal lines and the pixel electrodes, the parasitic capacitances are less likely to appear between the adjacent pixel electrodes. Therefore, even when the voltage polarity of the data signals is periodically altered, the voltage variations are less likely to occur at the pixel electrodes. This produces an effect to reduce the occurrence of uneveness.

The first interlayer insulator can be made of inorganic material while the second interlayer insulator can be made of organic material.

With the second interlayer insulator having the larger thickness than the first interlayer insulator and made of organic material, the layer designing including layer thickness control becomes easy and thus the layers can be easily formed.

The conductive parts are electrically connected to the gate signal lines or the hold capacitor lines between the pixel electrodes.

In this configuration, areas for electrically connecting the conductive parts to the gate signal lines or the hold capacitor lines are not required in an peripheral area around an active area in which the pixel electrodes are arranged. This contributes to reduction of a frame size. This configuration is effective when the adjacent conductive parts are electrically isolated from each other.

The conductive parts are arranged between the respective pixel electrodes so as to overlap any of the gate signal lines and the hold capacitor lines. Moreover, the conductive parts that are adjacent to each other in the extending direction of the gate signal lines or the hold capacitor lines are electrically connected to each other.

In this configuration, the conductive parts extend in the extending direction of the gate signal lines or the hold capacitor lines. This configuration provides a backup line structure in which the conductive parts function as backup lines for the gate signal lines or the hold capacitor lines even when they are broken.

The display device includes an active area in which a plurality of the pixel electrodes area arranged and a peripheral area located outside the active area. The conductive parts are electrically connected to at least one of the gate signal lines, the hold capacitor lines and the common electrode in the peripheral area.

This configuration is effective when areas for means for electrically connecting the conductive parts to the gate signal lines or the hold capacitor lines (e.g., contact holes) cannot be provided in the active area in which the pixel electrodes are arranged. To simplify the connecting structure, the conductive parts should be electrically connected to the common electrode in the peripheral area as in the above configuration.

The conductive parts are arranged between the respective pixel electrodes and the adjacent conductive parts are electrically isolated from each other.

In this configuration, the conductive parts that are electrically independent from each other between the respective pixel electrodes, that is, members for electrically connecting the conductive parts to each other are not required. This contributes to cost reduction.

The conductive parts do not have portions that overlap the data signal lines in plan view.

With this configuration, electrical fields are less likely to be generated between the conductive parts and the data signal lines and thus the electrical loads to the data signal lines can be reduced.

The display device includes a liquid crystal panel having liquid crystals sealed between a pair of substrates. Such a display device can be used as a liquid crystal display device in various applications, for example, televisions or desktop monitors of personal computers. It is particularly suitable for large screens applications.

The television receiver of the present invention includes the above display device.

Because the display device is less likely to produce display uneveness, the television receiver is also less likely to produce display uneveness and high display quality can be achieved.

### Advantageous Effect of the Invention

According to the display device of the present invention, high display quality can be achieved because display uneveness is less likely to occur even when driving the display device by periodically inverting the voltage polarity of driving signals. Furthermore, the television receiver of the present invention includes the display device in which the display uneveness is less likely to occur and thus high display quality without uneveness in television images can be achieved.

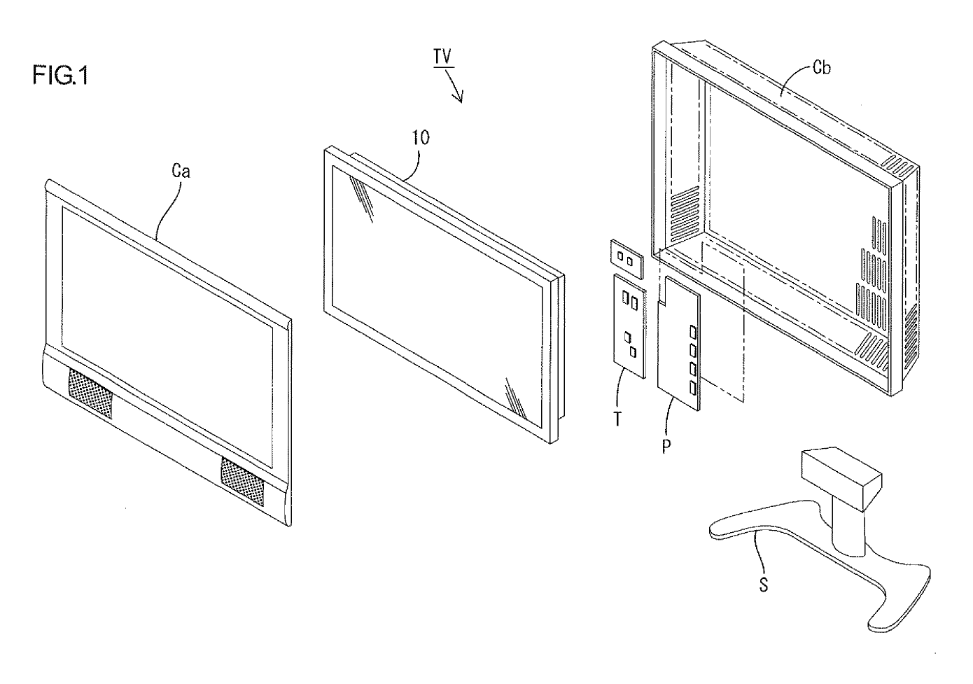

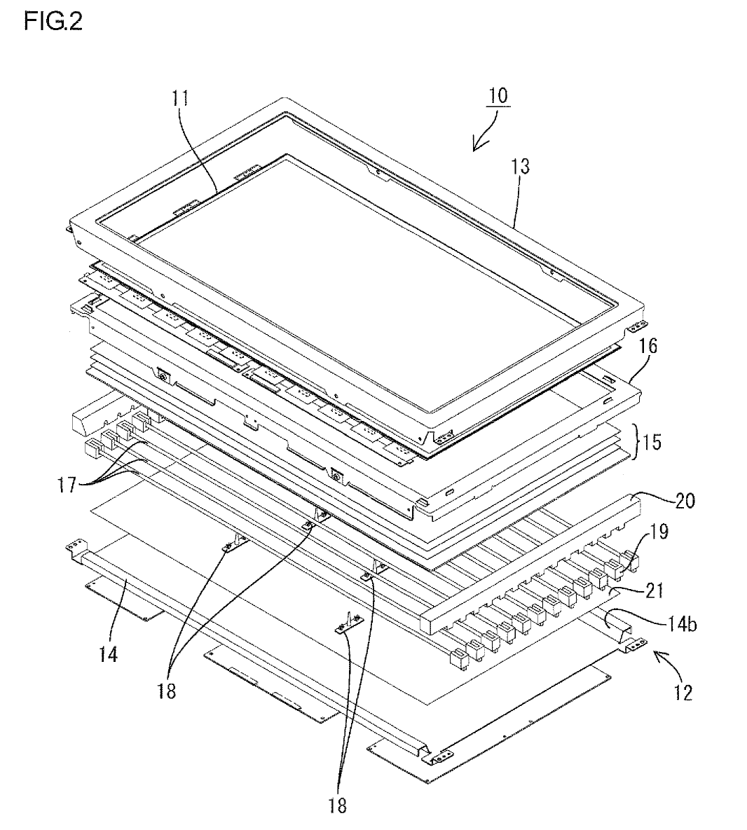

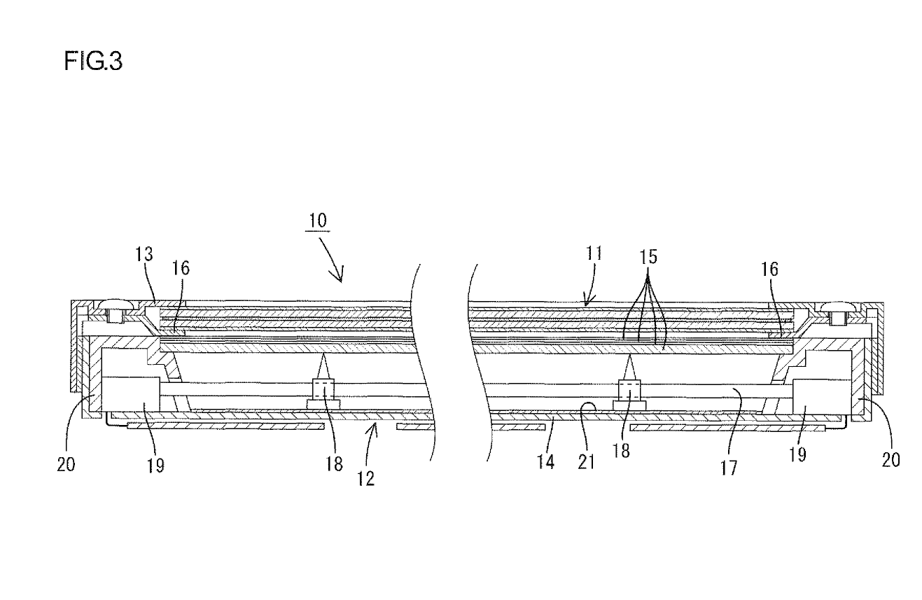

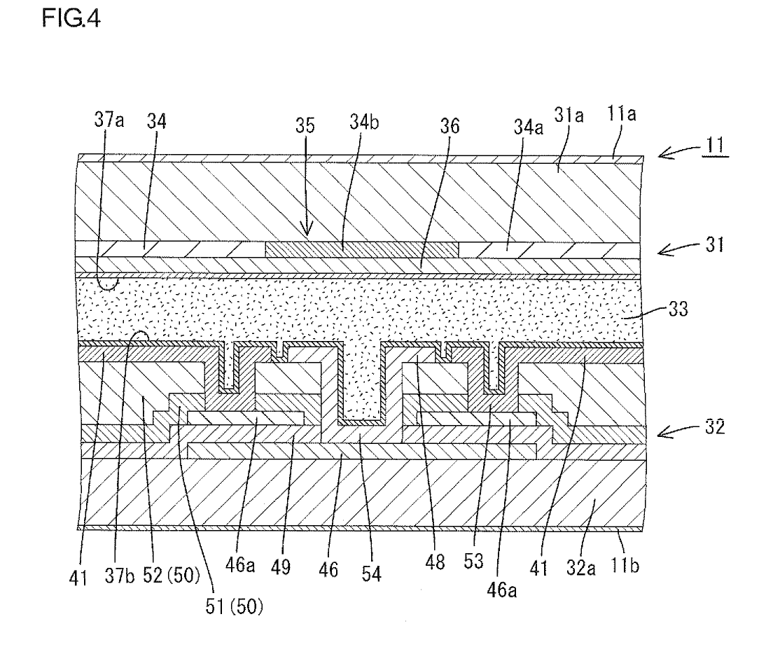

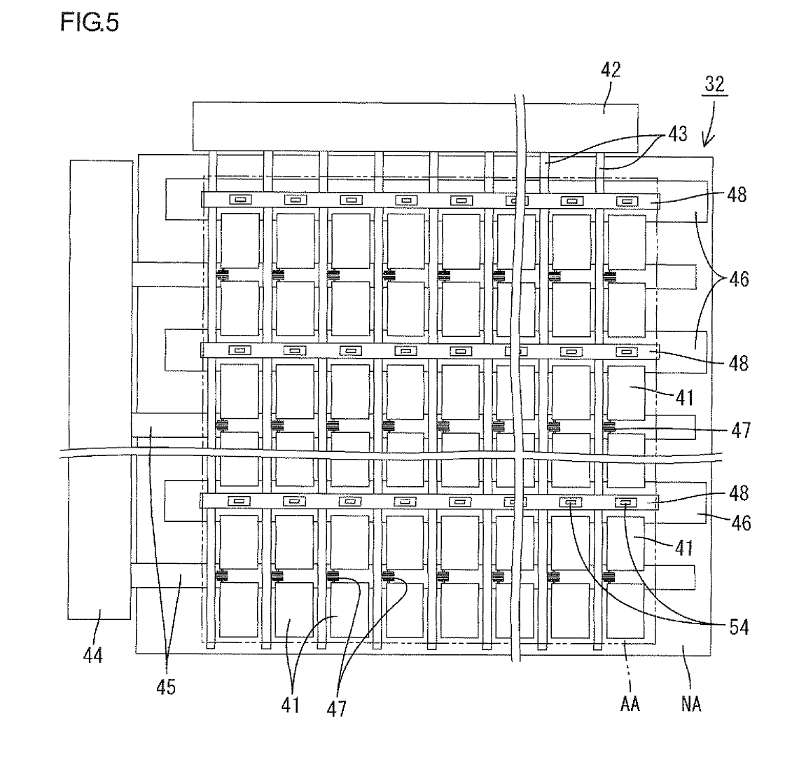

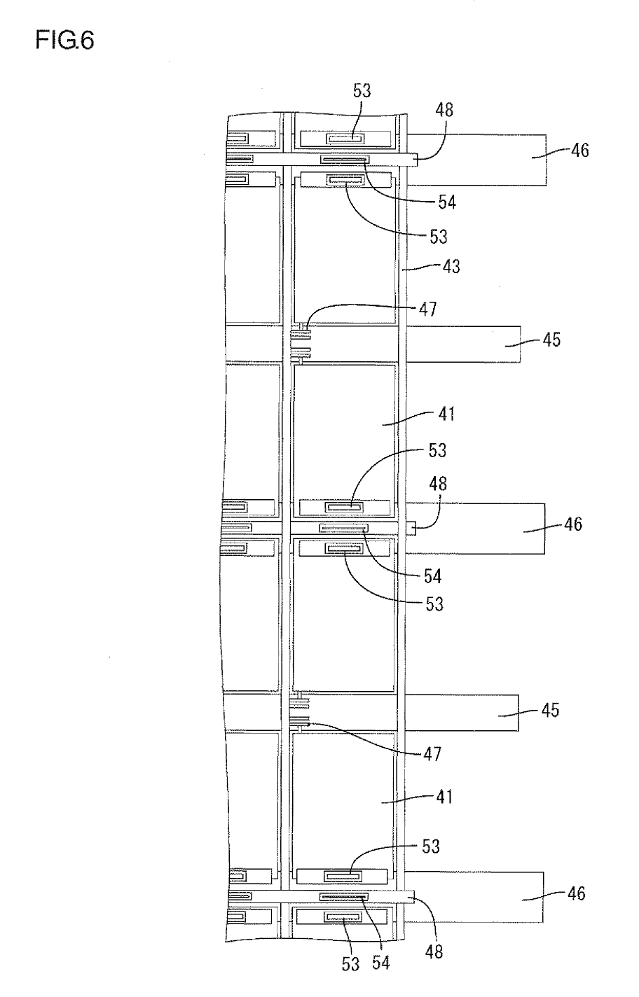

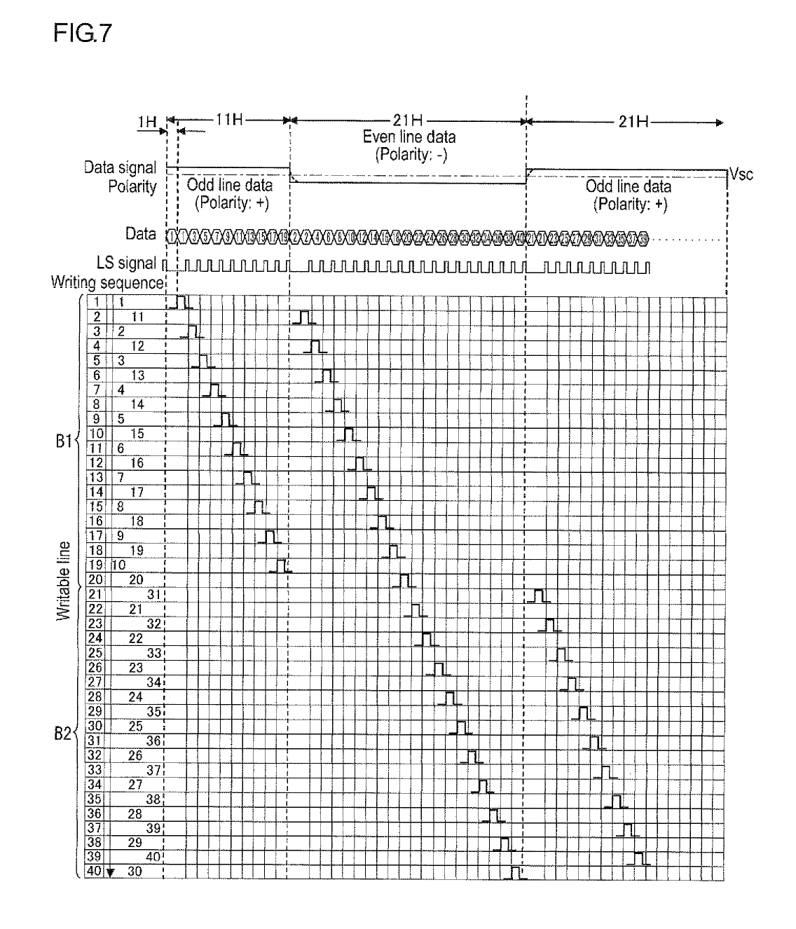

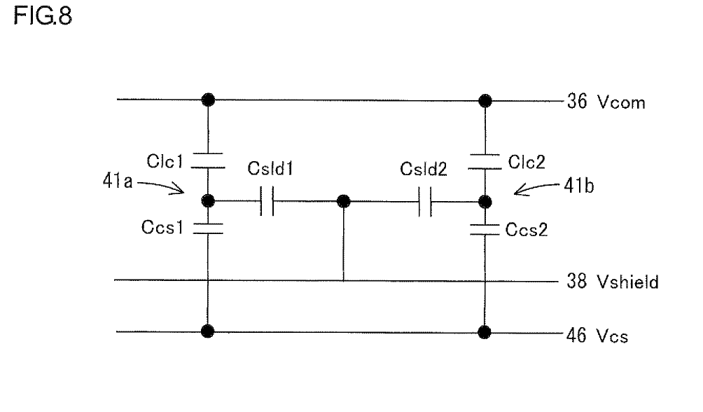

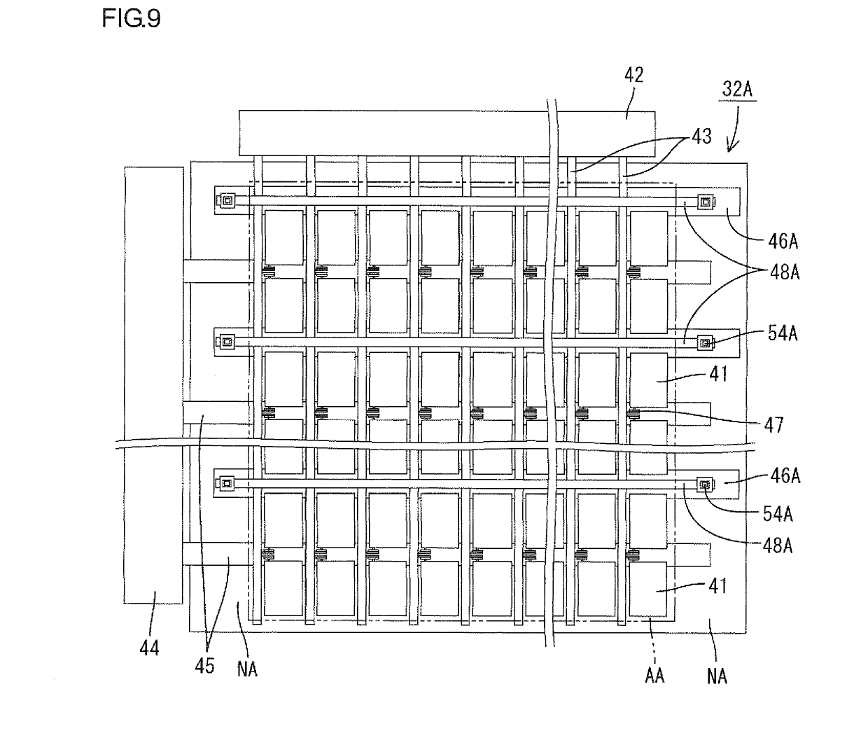

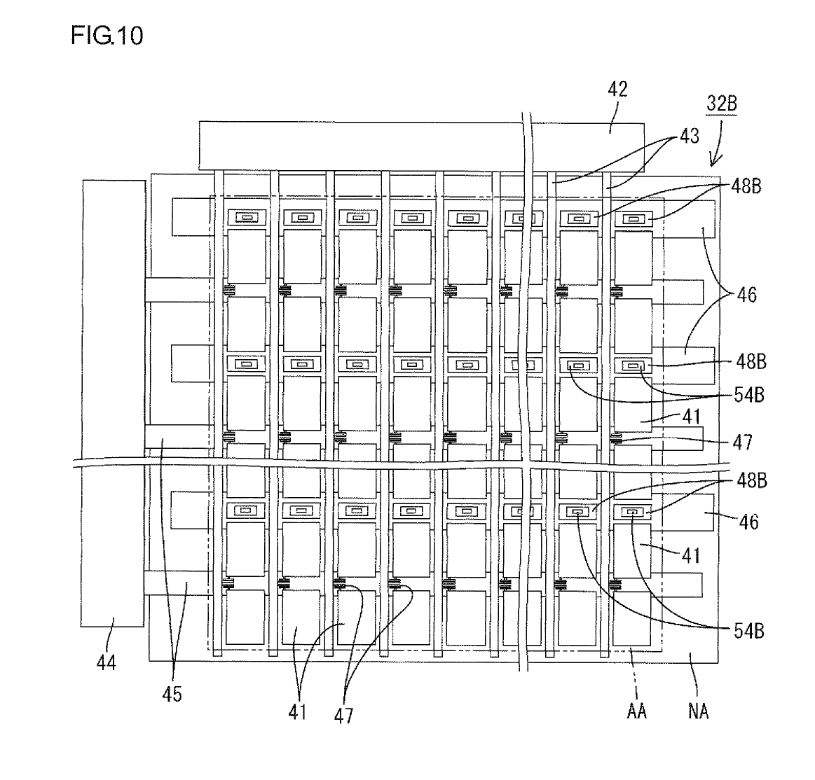

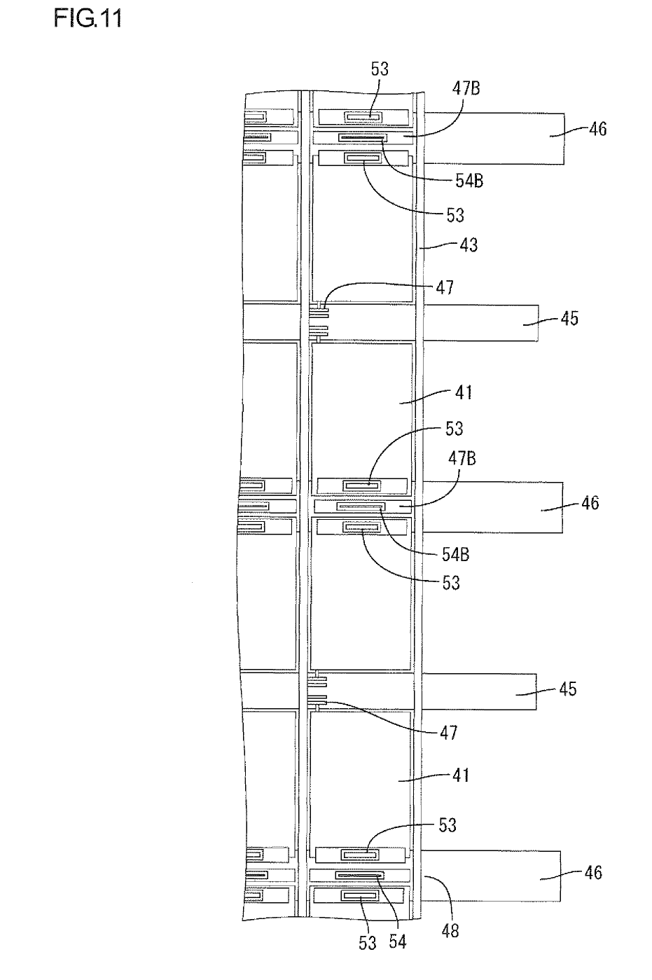

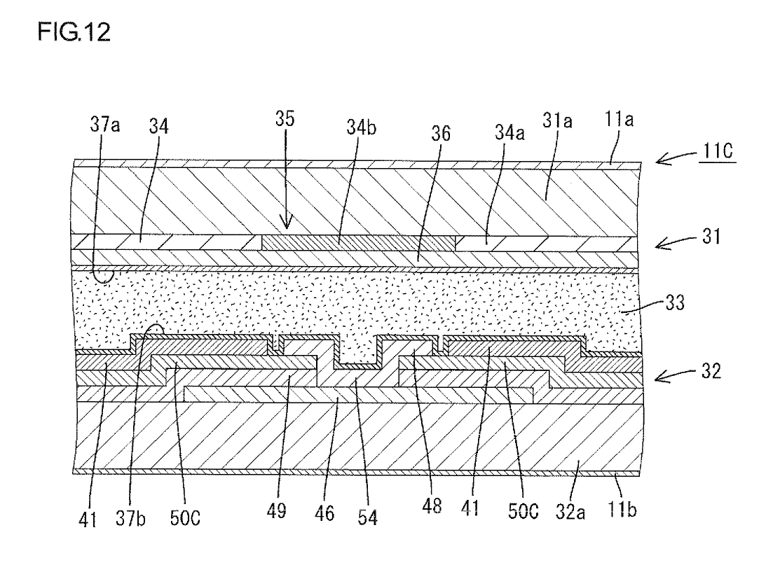

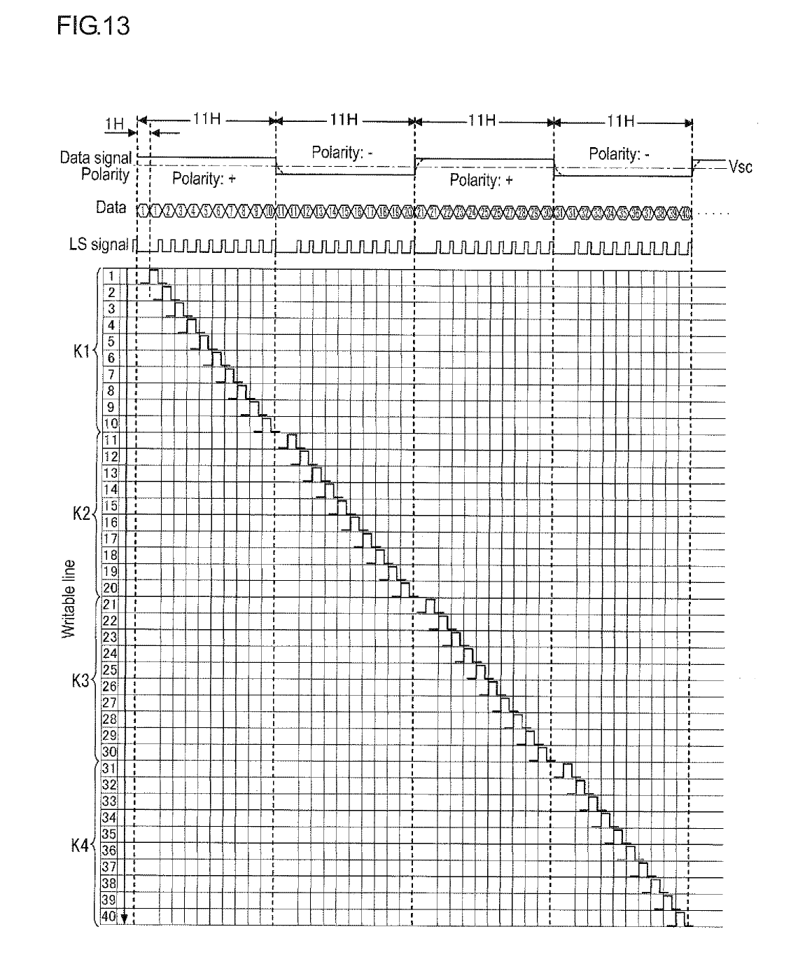

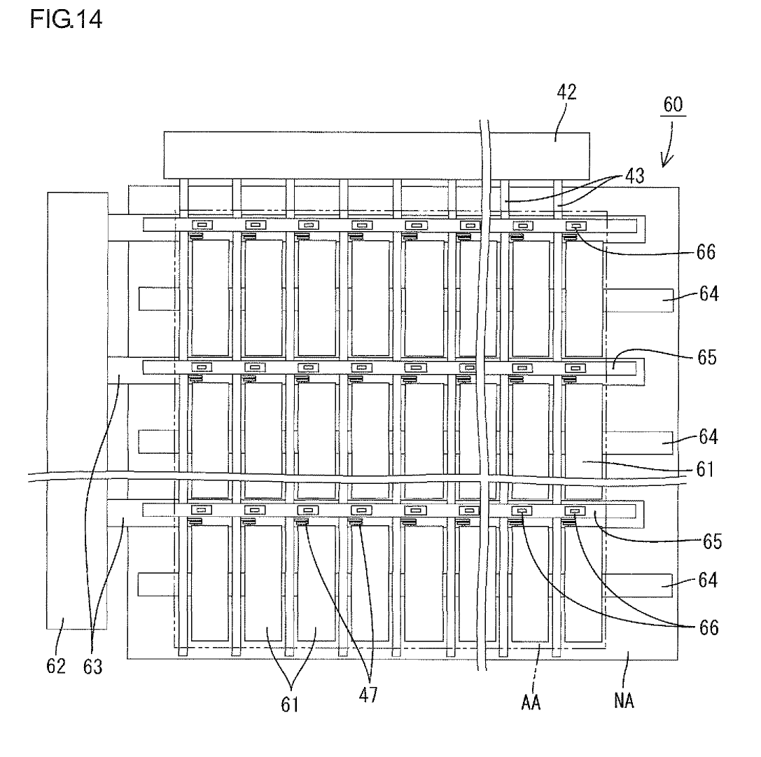

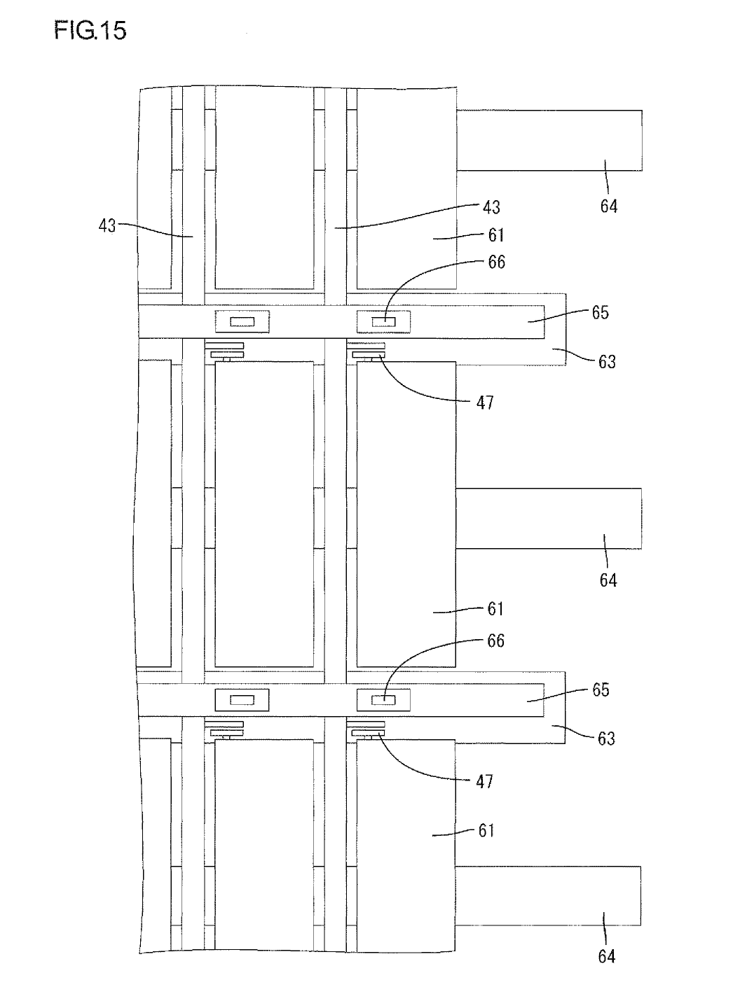

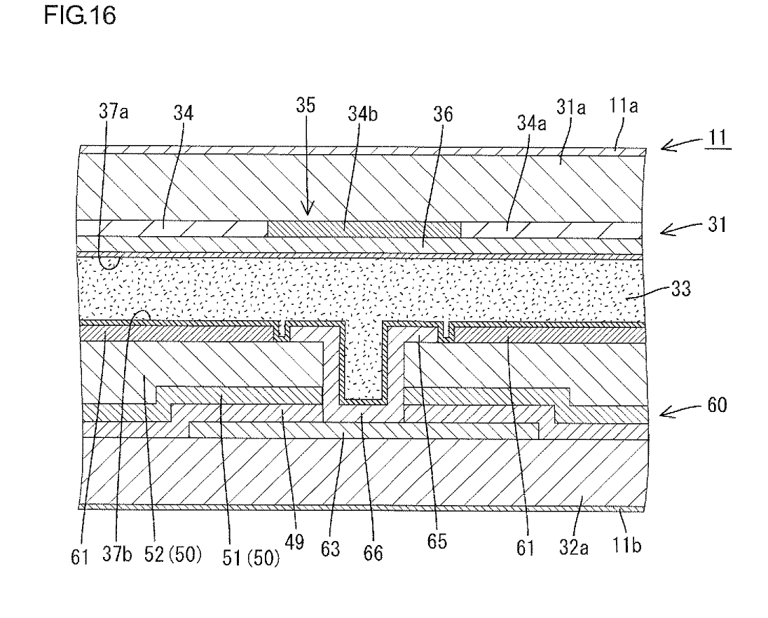

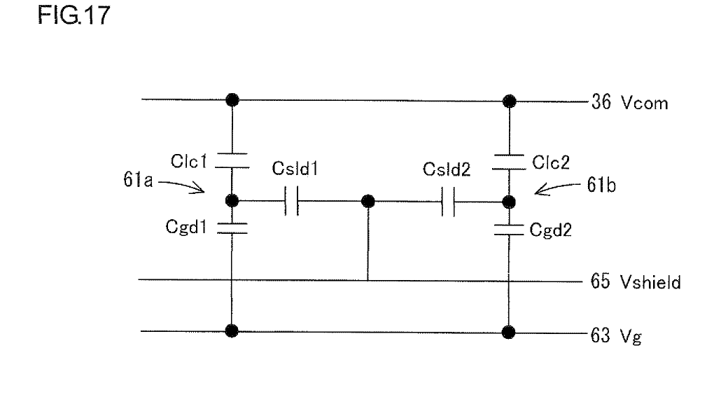

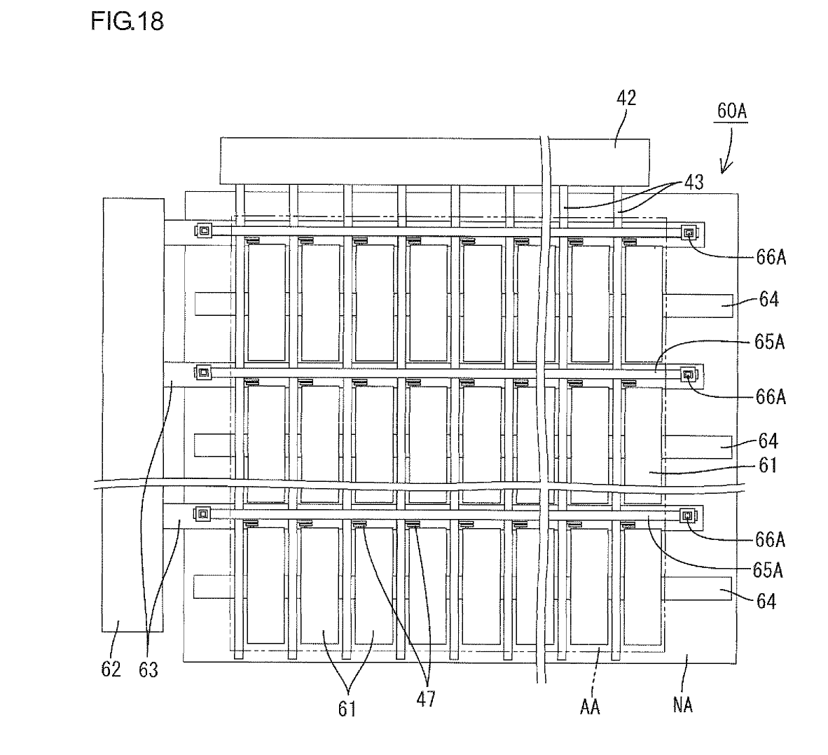

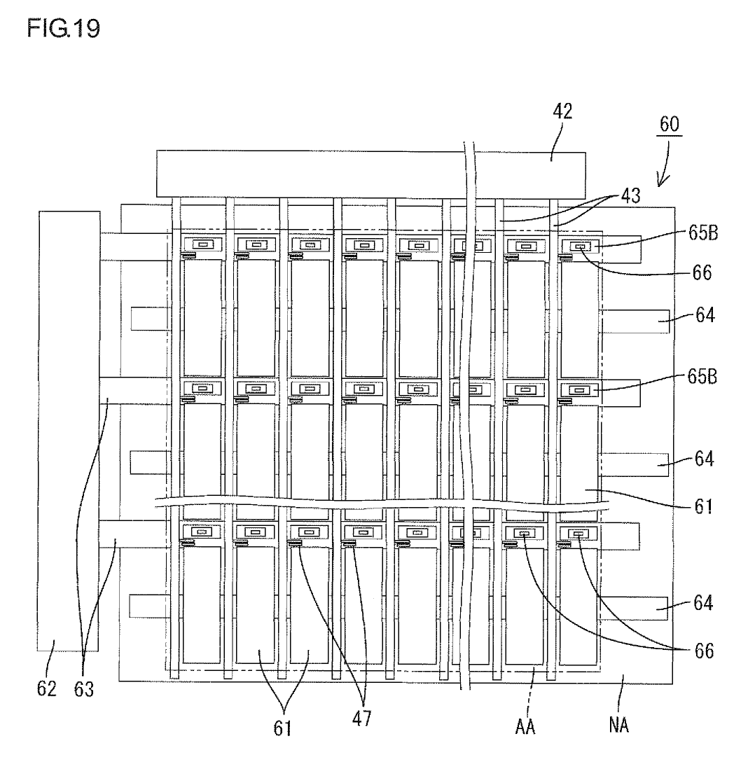

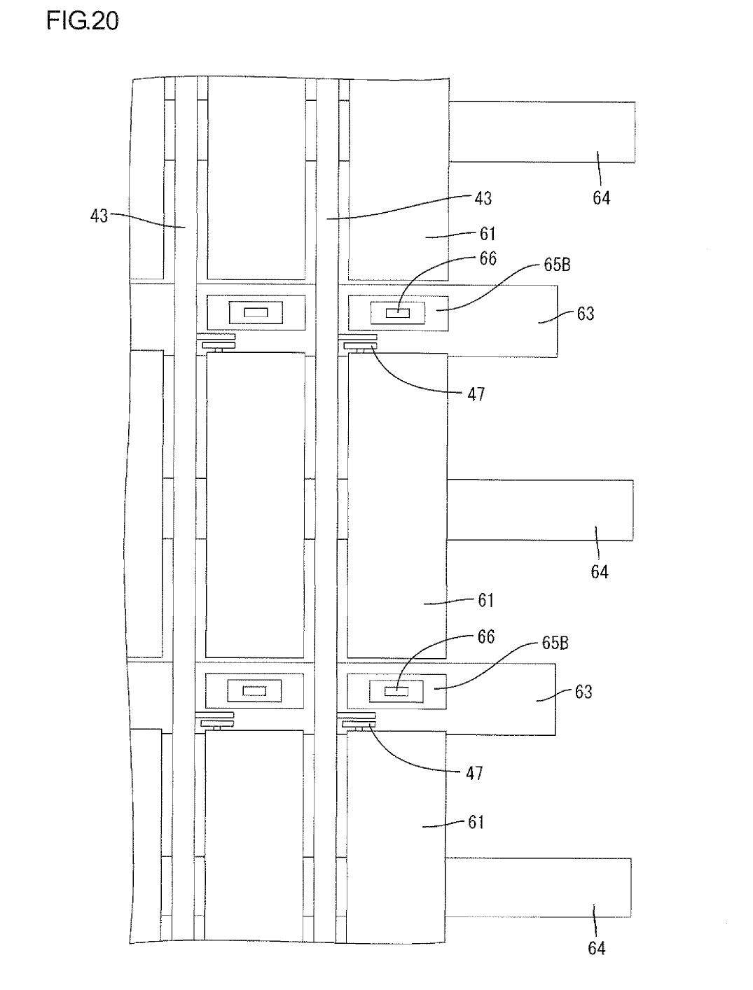

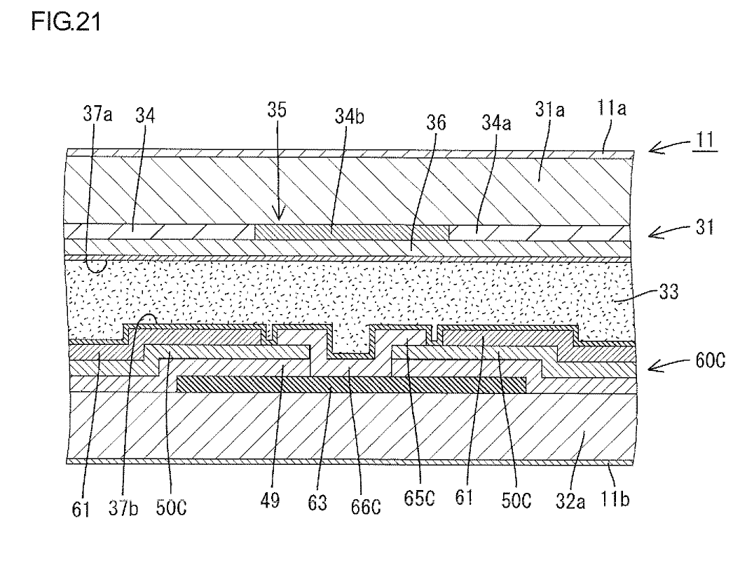

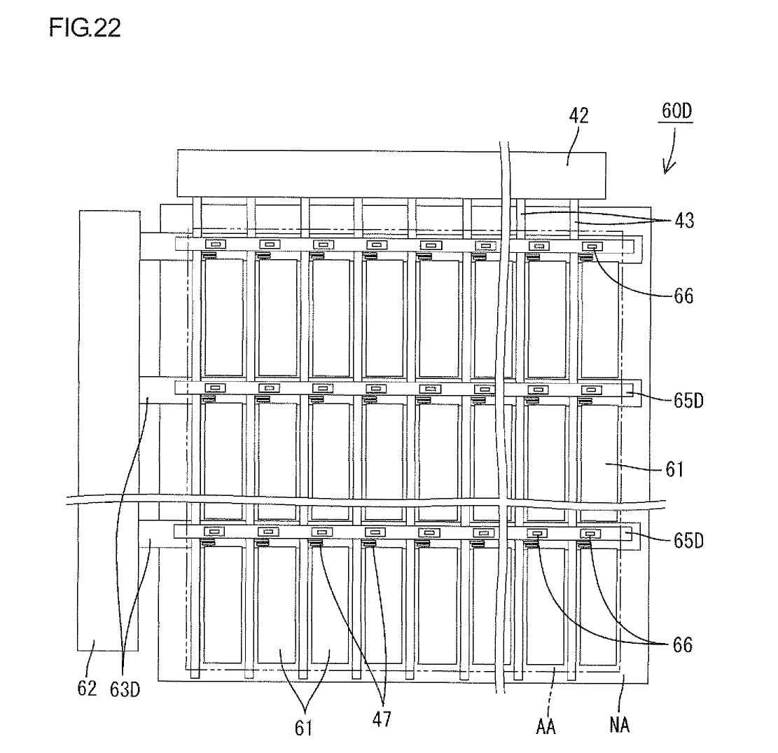

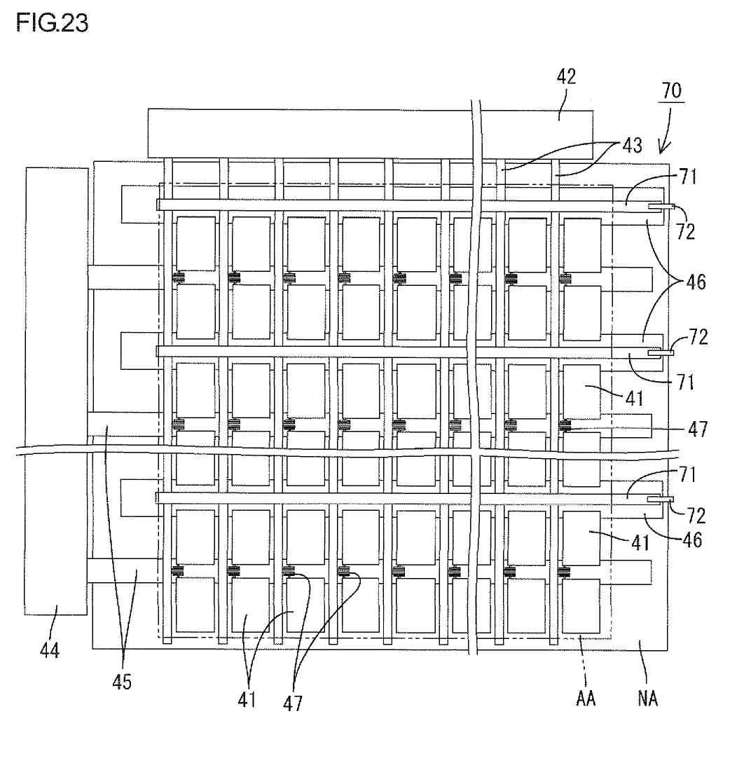

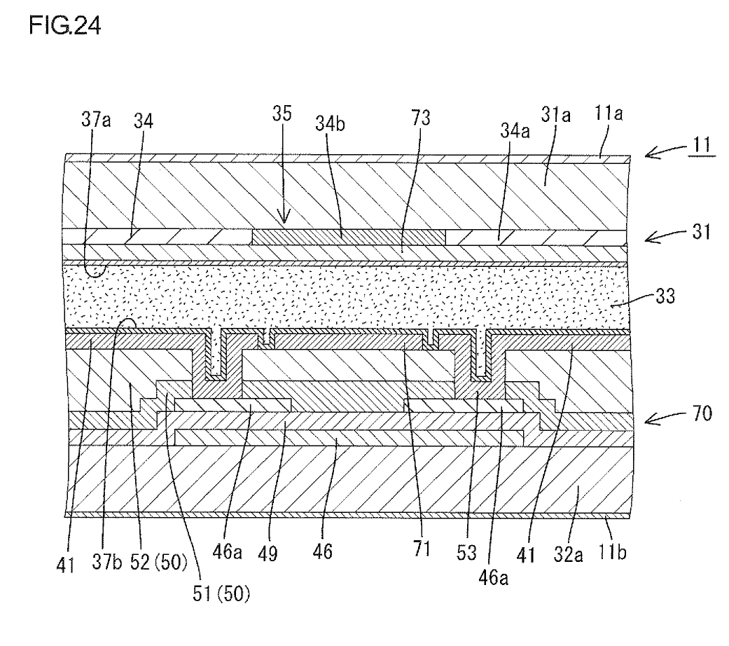

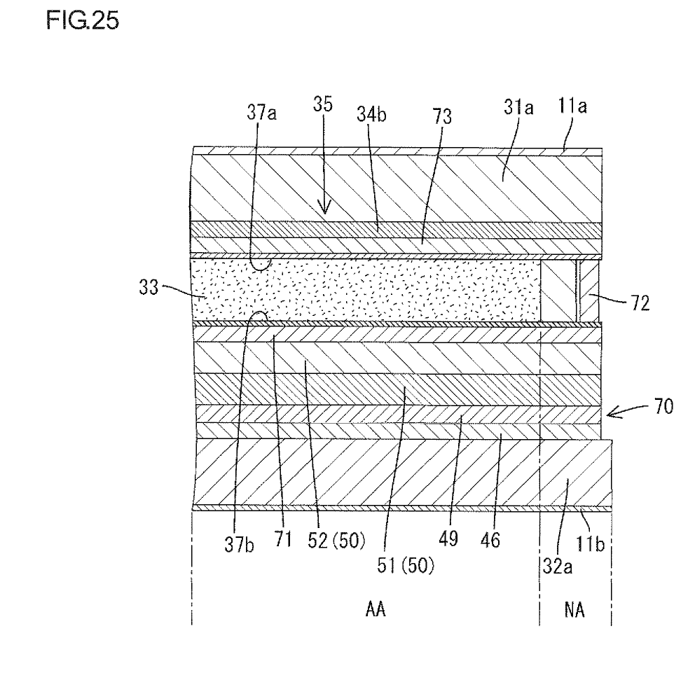

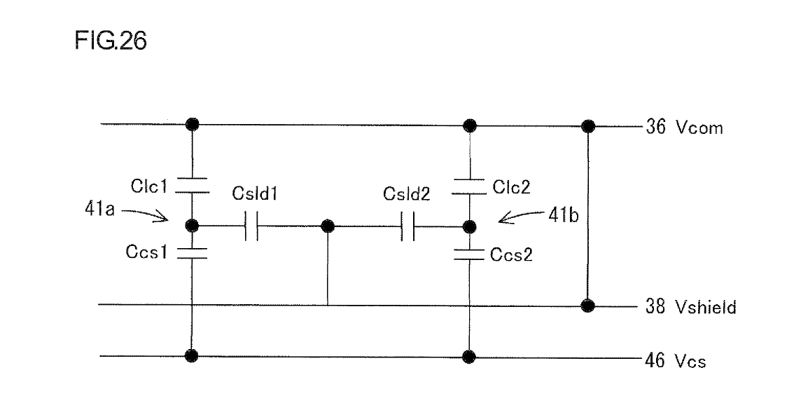

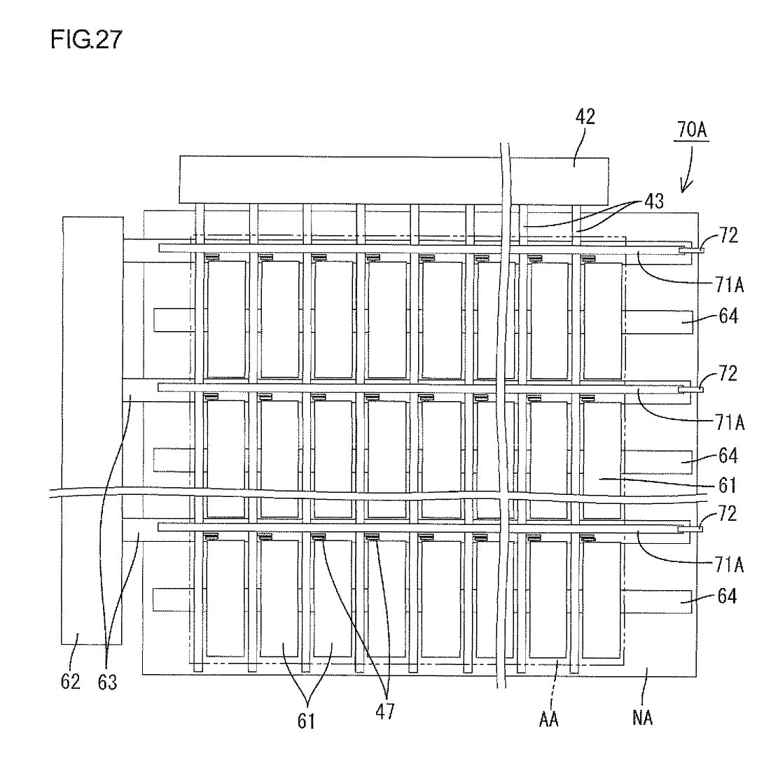

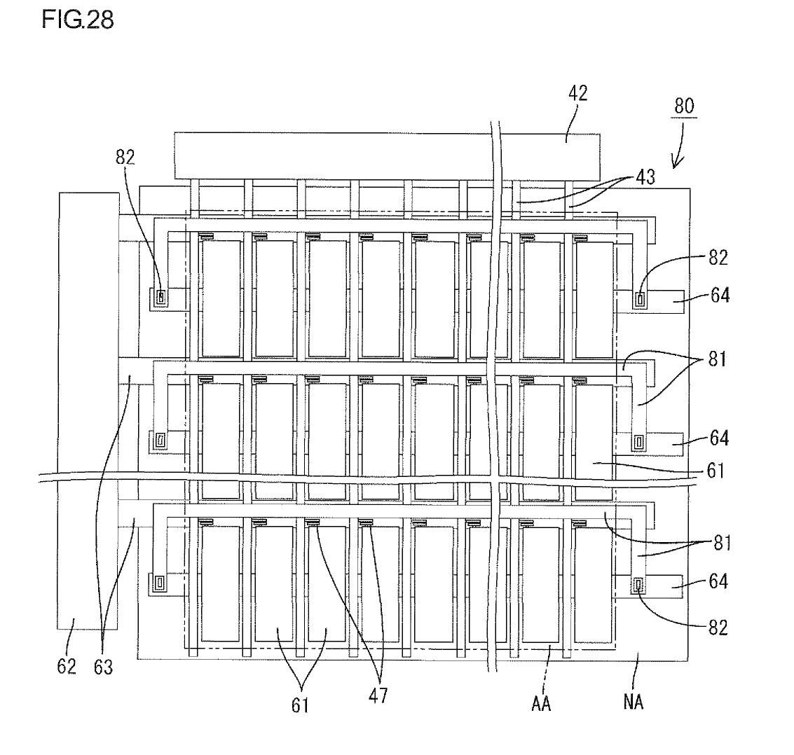

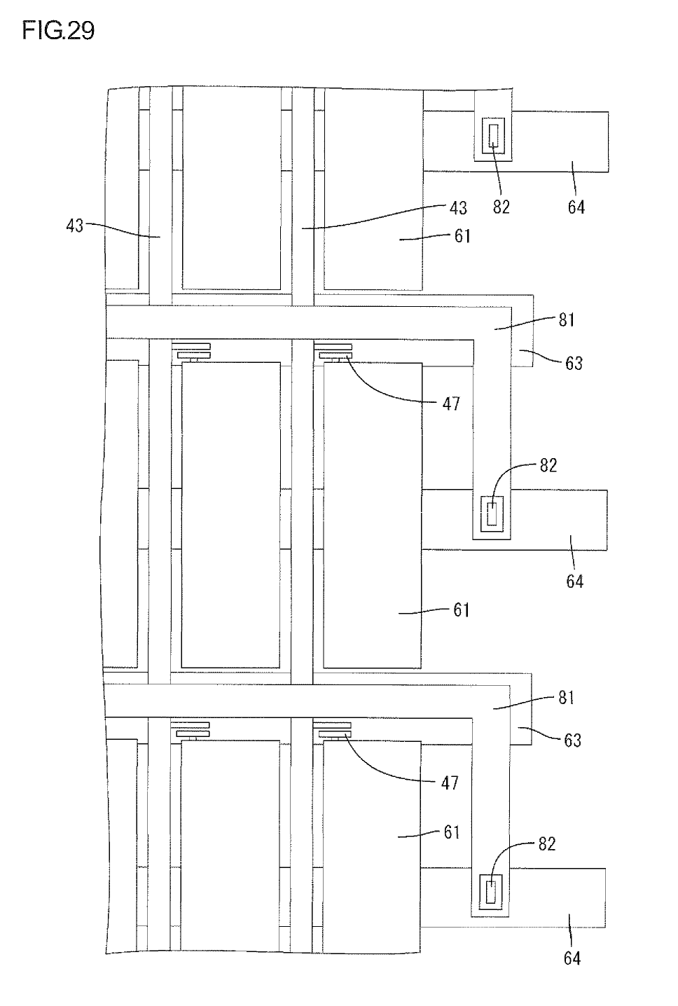

### BRIEF DESCRIPTION OF THE DRAWINGS

[FIG. 1] is an exploded perspective view illustrating a general construction of a television receiver according to the first embodiment of the present invention;

[FIG. 2] is an exploded perspective view illustrating a general construction of a liquid crystal display device included in the television receiver in FIG. 1;

[FIG. 3] is a cross-sectional view of the liquid crystal display device in FIG. 2 along the long-side direction thereof;

[FIG. 4] is a magnified cross-sectional view of a liquid crystal panel included in the liquid crystal display device in FIG. 2 around a central part of screen;

[FIG. 5] is a plan view schematically illustrating wiring patterns on an array board included in the liquid crystal panel in FIG. 4;

[FIG. 6] is a magnified view illustrating a relevant part of FIG. 5;

[FIG. 7] is a timing chart of data signals;

[FIG. 8] is an equivalent circuit schematically illustrating pixel electrodes located adjacent to each other in the liquid crystal panel;

[FIG. 9] is a plan view schematically illustrating a modification of the wiring patterns on the array board;

[FIG. 10] is a plan view schematically illustrating another modification of the wiring patterns on the array board;

[FIG. 11] is a magnified plan view of a relevant part of FIG. 10;

[FIG. 12] is a magnified cross-sectional view illustrating a part a modification of the liquid crystal panel between pixel electrodes;

[FIG. 13] is a timing chart of data signals for explaining a modification;

[FIG. 14] is a plan view schematically illustrating wiring patterns on an array board included in a liquid crystal display device according to the second embodiment of the present invention;

[FIG. 15] is a magnified plan view of a relevant part of FIG. 14;

[FIG. 16] is a magnified cross-sectional view of a liquid crystal panel around a central part of screen;

[FIG. 17] is an equivalent circuit schematically illustrating pixel electrodes located adjacent to each other in the liquid crystal panel;

[FIG. 18] is a plan view schematically illustrating a modification of the wiring patterns on the array board;

[FIG. 19] is a plan view schematically illustrating another modification of the wiring patterns on the array board;

[FIG. 20] is a magnified plan view of a relevant part of FIG. 19;

[FIG. 21] is a magnified cross-sectional view of a liquid crystal panel around a central part of screen;

[FIG. 22] is a plan view schematically illustrating another modification of the wiring patterns on the array board;

[FIG. 23] is a plan view schematically illustrating wiring patterns on an array board included in a liquid crystal display device according to the third embodiment of the present invention;

[FIG. 24] is a magnified cross-sectional view of a liquid crystal panel included in the liquid crystal display device in FIG. 23 around a central part of screen;

[FIG. 25] is a magnified cross-sectional view of a liquid crystal panel in FIG. 24 around an edge part of screen;

[FIG. 26] is an equivalent circuit schematically illustrating pixel electrodes located adjacent to each other in the liquid crystal panel;

[FIG. 27] is a plan view schematically illustrating another modification of the wiring patterns on the array board;

[FIG. 28] is a plan view schematically illustrating wiring patterns on an array board included in a liquid crystal display device according to the fourth embodiment of the present invention; and

[FIG. 29] is a magnified plan view of a relevant part of FIG. 29.

### EXPLANATION OF SYMBOLS

10: Liquid crystal display device (Display device)

11: Liquid crystal panel

36: Common electrode

41: Pixel electrode

43: Data signal line

45: Gate signal line

46: Hold capacitor line

47: TFT (switching component)

48: Shield electrode (conductive part)

50: Interlayer insulator

51: First interlayer insulator

52: Second interlayer insulator

AA: Active area

NA: Peripheral area

TV: Television receiver

### BEST MODE FOR CARRYING OUT THE INVENTION

### First Embodiment

The first embodiment of the present invention will be explained with reference to FIGS. 1 to 9. In this embodiment, a television receiver TV including a liquid crystal display device 10 will be used as an example.

FIG. 1 is an exploded perspective view illustrating a general construction of the television receiver of this embodiment. FIG. 2 is an exploded perspective view illustrating a general construction of the liquid crystal display device. FIG. 3 is a cross-sectional view of the liquid crystal display device in FIG. 2 along the long-side direction thereof.

As illustrated in FIG. 1, the television receiver TV of this embodiment includes a liquid crystal display device 10, front and rear cabinets Ca, Cb that house the liquid crystal display device 10 therebetween, a power source P, a tuner T for receiving TV broadcasting and a stand S. The liquid crystal display device (display device) 10 has a landscape rectangular overall shape and housed in a vertical position. As illustrated in FIG. 2, the liquid crystal display panel 10 includes a liquid crystal panel 11, which is a display panel, and a backlight unit 12, which is an external light source. They are held together with a bezel 13.

Next, the liquid crystal panel 11 and the backlight unit 12 included in the liquid crystal display device 10 will be explained (see FIGS. 2 and 3).

The backlight unit 12 is a direct backlight unit. It includes a plurality of light sources (cold cathode tubes 17 that high-pressure discharge tubes are used here) arranged directly behind a rear surface of the liquid crystal panel 11 (i.e., an opposite surface from a display surface) along the panel surface.

The backlight unit 12 includes a chassis 14, an optical member 15 and a frame 16. The chassis 14 has a substantially box shape with an opening 14b on the top. The optical member 15 (including a diffuser plate, a diffuser sheet, a lens sheet and a reflection type polarizing plate in this order from the bottom of FIGS. 2 and 3) is arranged so as to cover the opening 14b of the chassis 14. The frame 16 holds the optical member 15 to the chassis 14. The cold cathode tubes 17, lamp clips 18, lamp holders 19 and holders 20 are housed in the chassis 14. The lamp clips 18 are used for mounting the cold cathode tubes 17 to the chassis 14. The lamp holders 19 supports ends of the cold cathode tubes 17. The holders 20 collectively cover the ends of the cold cathode tubes 17 and the lamp holders 19. A light output side of the backlight unit 12 is a side closer to the optical member 15 than the cold cathode tubes 17.

The chassis 14 is made of metal. The chassis 14 is formed in a substantially shallow box shape having a rectangular bottom plate and side plates, each of which extends upright from the corresponding side of the bottom plate. A light reflecting sheet 21 is disposed on a side opposite from the light output side of the cold cathode tubes 17 (i.e., on an inner surface of the bottom plate of the chassis 14). The light reflecting sheet 21 has a surface in white color that provides high light reflectivity and provides a light reflecting surface.

Each cold cathode tube 17 has an elongated tubular shape. A plurality of the cold cathode tubes 17 are installed in the chassis 14 such that they are arranged parallel to each other with the long-side direction thereof (the axial direction) aligned along the long-side direction of the chassis 14 (see FIG. 2). Each cold cathode tube 17 is held with the lamp clips 18 slightly away from the bottom plate 14a (or the reflecting sheet 21). Each lamp clip 18 is made of synthetic resin in white. Each end of each cold cathode tube 17 is fitted in the corresponding lamp holder 19. The holders 20 are mounted so as to cover the lamp holders 19.

Next, the liquid crystal display panel 11 will be explained. FIG. 4 is a magnified cross-sectional view of the liquid crystal panel around a central part of screen. FIG. 5 is a plan view schematically illustrating wiring patterns on an array board included in the liquid crystal panel in FIG. 4. FIG. 6 is a magnified plan view of a relevant part of FIG. 5.

As illustrated in FIG. 4, the liquid crystal panel 11 includes a pair of landscape rectangular substrates 31 and 32 and a liquid crystal layer 33 formed between the substrates 31 and 32. The liquid crystal layer 33 has optical characteristics that change according to voltage application. Front and rear polarizing plates 11a and 11b are arranged on respective outer surfaces (away from the liquid crystal layer 33) of the substrates 31 and 32.

The substrate 31 arranged on the front side (display side) is configured as a CF board 31 and the substrate 32 on the rear side (backlight unit 12 side) is configured as an array board 32. The array board 32 includes a transparent glass substrate 32a (capable of light transmission). As illustrated in FIGS. 5 and 6, signal lines are formed in a grid pattern on an inner surface of the glass substrate 32a (on a liquid crystal layer 33 side or the surface opposite the CF board 31). A plurality of pixel electrodes 41 in a rectangular shape are arranged in a matrix such that each of them is surrounded by the signal lines. The data signal lines 43 are formed on the array board 32 in a column direction (vertical direction in FIGS. 5 and 6) and connected to a data driver 42. The gate signal lines 45 connected to a gate driver 44 and hold capacitor lines 46 extend in a row direction (horizontal direction in FIGS. 5 and 6). They are alternately arranged. Hold capacitances appear between the hold capacitor lines 46 and the pixel electrodes 41. In this embodiment, the gate signal lines 45 and the hold capacitor lines 46 are arranged between the respective adjacent pixel electrodes 41, 41. Moreover, the thin film transistors (TFTs) 47 that are switching components are connected to the respective pixel electrodes 41. A drain electrode, a source electrode and a gate electrode of each TFT 47 are connected to the corresponding pixel electrode 41, data signal line 43 and gate signal line 45, respectively. In FIG. 6, two pixel electrodes 41 located adjacent to each other in the column direction form one pixel unit of the liquid crystal display device 10. The TFTs 47, 47 connected to the respective pixel electrodes 41 adjacent to each other are arranged on the same gate signal line 45. In FIG. 5, an area in which the pixel electrodes 41 are arranged in a matrix is an active area AA (inside alternate long and two short dashes lines in FIG. 5) in which images can be displayed. A frame-shape area outside the active area AA around the edges thereof is a peripheral area NA (outside the alternate long and two short dashes lines in FIG. 5) in which images cannot be displayed.

The CF board 31 includes a color filter 35 including a number of colored portions 34a and light blocking portions 34b formed on the inner surface of the transparent glass substrate 31a (capable of light transmission). The inner surface of the glass substrate 31a is located on the liquid crystal layer 33 side, that is, close to the array board 32. The color filter 35 is positioned so as to face the pixels electrodes 41. The colored portions 34a include Red (R), Green (G) and Blue (B) portions arranged in predetermined locations. The light blocking portions 34b are arranged between the respective adjacent colored portions 34a so that color mixture does not occur. A common electrode 36 are provided on surfaces of the colored portions 34a and the light blocking portions 34b so as to face the pixel electrodes 41 on the array board 32. A voltage can be applied across the pixel electrodes 41 and the common electrode 36. An alignment film 37a is formed on the surface of the common electrode 36 for aligning the liquid crystal molecules in the liquid crystal layer 33.

Shield electrodes (conductive parts) 48 are arranged between the respective adjacent pixel electrodes 41, 41 on the array board 32 so as to overlap the respective hold capacitor lines 46. Each shield electrode 48 extends from one end of the active area AA to the other end along the hold capacitor line 46. Namely, each shield electrode 48 between the adjacent pixel electrodes 41, 41 is provided along the corresponding hold capacitor line 46 and electrically connected thereto. “The adjacent pixel electrodes” are not the pixel electrodes 41, 41, activation of which is controlled through the gate electrodes connected to the same gate signal line 45. They are the pixel electrodes 41, 41, activation of which is controlled through the gate electrodes connected to the different gate signal lines 45, 45. Namely, they are not the pixel electrodes 41, 41 arranged either side of the gate signal line 45 but ones arranged either side of the hold capacitor line 46.

A layered structure of the pixel electrodes 41, the hold capacitor lines 46 and the shield electrodes 48 will be explained with reference to FIG. 4.

The hold capacitor lines 46 are formed on the glass substrate 32a of the array board 32 similarly to the gate signal lines 45 (not shown in FIG. 4). Gate insulators 49 are formed so as to cover the hold capacitor lines 46 and the surface of the glass substrate 32a. The gate insulators 49 are provided for electrically isolating the gate signal lines from the peripheral components. Over-hold-capacitor electrodes 46a are provided on the gate insulator 49 in areas that overlap the ends of the hold capacitor lines 46. Each over-hold-capacitor electrode 46a functions as an electrode of the hold capacitor, the other electrode of which is the hold capacitor line 46. Interlayer insulators 50 having a two-layer structure are formed so as to cover the over-hold-capacitor electrodes 46a and the gate insulators 49. The pixel electrodes 41 and the shield electrodes 48 are disposed on the interlayer insulator 50. The shield electrodes 48 can be made of the same material as the pixel electrodes 41 (e.g., transparent conductive material including ITO and IZO). An alignment film 37b are formed on the surfaces of the pixel electrodes 41 and the shield electrodes 48 for aligning the liquid crystal molecules in the liquid crystal layer 33.

The interlayer insulator 50 having a two-layer structure includes the first interlayer insulator 51 disposed on the lower side (on the glass substrate 32a side, or the hold capacitor line 46 and gate signal line 45 side). The first interlayer insulator 51 is an inorganic interlayer insulator made of inorganic material such as SiNx. The interlayer insulator 50 further includes the second interlayer insulator 52 disposed in the upper side (on the liquid crystal layer 33 side, or the pixel electrode 41 and shield electrode 48 side). The second interlayer insulator 52 having a larger thickness than the first interlayer insulator is an organic interlayer insulator made of organic material selected from acrylic resin, epoxy resin, polyimid resin, polyurethane resin, novolak resin and siloxane resin, whatever is suitable.

An inter-electrode contact 53 between the pixel electrode 41 and the over-hold-capacitor electrode 46a is formed in an area of each pixel electrode 41 overlapping the over-hold-capacitor electrode 46a (i.e., one of the ends). The inter-electrode contact 53 is shaped such that the pixel electrode 41 passes through the second interlayer insulator 52 and the first interlayer insulator 51, and then contacts the over-hold-capacitor electrode 46a (i.e., being electrically connected). With this inter-electrode contact 53, the hold capacitance appears between the pixel electrode 41 and the hold capacitor line 46 via the over-hold-capacitor electrode 46a and the gate insulator 49.

Each shield electrode 48 has a shield electrode-hold capacitor line contact 54 shaped such that the shield electrode 48 passes through the second interlayer insulator 52, the first interlayer insulator 51 and the gate insulator 49, and then contacts the hold capacitor line 46 (i.e., being electrically connectable). The shield electrode 48 and the hold capacitor line 46 are electrically connected with each other via the shield electrode-hold capacitor line contact 54.

Next, a method of driving the liquid crystal panel 11 of this embodiment will be explained with reference to FIG. 7. FIG. 7 is a timing chart of data signals.

In FIG. 7, the first column contains the numbers of writable lines to which signals are fed. The numbers in this chart correspond to the first to the fortieth gate signal lines 45 in the arrangement. The second column contains data signal writing sequence numbers. Data signal writing timing is illustrated in a main part of FIG. 7. Voltage polarities of the data signals, the data numbers (No.) and transmission timing of IS signals are shown in the upper part of FIG. 7.

The gate signal lines 45 are grouped into blocks according to sequence numbers in the arrangement shown in the first column in FIG. 7, Each block contains twenty gate signal lines 45. The gate signal lines 45 indicated by sequence numbers of 1 to 20 are in the first block B1 and 21 to 40 are in the second block B2. The other gate signal lines 45 are also grouped into blocks for every twenty of them.

First, the gate signal lines 45 on odd lines in the first block B1 are scanned from the first line to the nineteenth line. Data signals sent to the data signal lines 43 during the driving of the TFTs 47 connected to the gate signal lines 45 on the odd lines, that is, the data signals corresponding to the gate signal lines 45 on the odd lines have a positive voltage polarity with respect to a reference voltage. Next, the gate signal lines 45 on even lines in the first block B1 are scanned from the second line to the twentieth line. Data signals corresponding to the gate signal lines 45 on the even lines have a negative (inverted) voltage polarity. Namely, the data signals fed to the data signal lines 43 have the voltage polarity different from the voltage polarity of the data signals for the gate signal lines 45 on the odd lines. Dummy time (additional time) is set for the first data signal after the voltage polarity of the data signals is altered to negative. This improves a reaching rate that indicates how close an actual voltage reaches the application voltage level (i.e., charging rate) after the voltage polarity of the data signals is altered from positive to negative (i.e., inverted).

After the transmission of signals in the first block B1 is complete, signals are sent to the signal lines 43 and 45 in the second block B2. In the second block 32, the gate signal lines 45 on the even lines from the 22^{nd} line to the 40^{th} line. The data signals corresponding to the gate signal lines 45 on the even lines have a negative voltage polarity, which is the same voltage polarity in the first block B1. Next, the gate signal lines 45 on the odd lines from the 21^{st} line to the 39^{th} line. The voltage polarity of the data signals corresponding to the gate signal lines 45 on the odd lines is altered (or inverted) to positive and the data signals are sent to the data signal lines 43. Dummy time (additional time) is set for the first data signal after the voltage polarity of the data signals is altered to positive. This improves the reaching rate (charging rate) that indicates how close the actual voltages reach the application voltages after the voltage polarity of the data signals is altered from negative to positive (i.e., inverted).

Although the data signals corresponding to the gate signal lines on the 41^{st} or higher lines are not shown in FIG. 7, the gate signal lines 45 on the even lines are scanned first and then those on the odd lines are scanned. Alternatively, the gate signal lines 45 on the odd lines area scanned first and then those on the even lines are scanned. The voltage polarity of the data signals sent during the driving of the TFTs 47 connected to the gate signal lines 45 on the even lines with respect to the reference voltage and the voltage polarity of the data signals sent during the driving of the TFTs 47 connected to the gate signal lines 45 on the odd lines with respect to the reference voltage are different from each other. In consideration of display uneveness reduction or power saving, the voltage polarity of the data signals should not be altered (or inverted) for two adjacent blocks such as between the first block B1 and the second block B2.

Next, operation of the liquid crystal panel 11 having the above configuration and being driven by the above method above will explained with reference to an equivalent circuit illustrated in FIG. 8.

The pixel electrodes 41a in FIG. 8 receive the data signals with positive voltage polarity corresponding to the gate signal lines 45 on the odd lines. The pixel electrodes 41b in FIG. 8 receive the data signals with negative voltage polarity corresponding to the gate signal lines 45 on the even lines. Between each pixel electrode 41a and the common electrode 36 that faces the pixel electrode 41a via the liquid crystal layer 33, a liquid crystal capacitance Clc1 exist. A liquid crystal capacitance Clc2 exists between each pixel electrode 41b that is adjacent to the pixel electrode 41a and the common electrode A hold capacitance Ccs1 exists between the pixel electrode 41a and the hold capacitor line 46. A hold capacitance Ccs2 exists between the pixel electrode 41b and the hold capacitor line 46. Moreover, shield capacitances Csld1 and Csld2 appear when the shield electrode 48 connected to the hold capacitor line 46 is disposed between the adjacent pixel electrodes 41a and 41b.

With the above method, the data signals with positive voltage polarity are sent to the pixel electrodes 41a. After the TFTs 47 connected to the pixel electrodes 41a are turned off, the data signals with negative voltage polarity are sent to the pixel electrodes 41b. If the shield electrodes 48 are not provided between the respective pixel electrodes 41a and 41b, parasitic capacitances appear between the pixel electrodes 41a and 41b. As a result, the pixel electrodes 41a and 41b may electrically affect each other due to the parasitic capacitances. Specifically, the negative voltages applied to the pixel electrodes 41b affect the positive voltages at the pixel electrodes 41a connected to the TFTs 47 that are turned on due to the parasitic capacitances. Therefore, the positive voltages may decrease.

Because the shield electrodes 48 are provided between the pixel electrodes 41a and 41b in this embodiment, the shield capacitances Csld1 and Csld2 exist between the pixel electrode 41a and the shield electrode 48, and the pixel electrode 41b and the shield electrode 48, respectively. Moreover, the shield electrodes 48 are electrically connected to the hold capacitor lines 46 and thus the balances between the shield capacitances Csld1 and Csld2 can be maintained. Because the shield capacitances Csld1 and Csld2 are stable, the parasitic capacitances are less likely to appear between the pixel electrodes 41a and 41b.

In the liquid crystal display device 10 of this embodiment, the gate signal lines 45 and the hold capacitor lines 46 are arranged between the respective adjacent pixel electrodes 41, 41 that are arranged along the extending direction of the data signal lines 43. Further, the shield electrodes 48 are provided between the respective adjacent pixel electrodes 41 (41a, 41b) on the hold capacitor lines 46. Still further, the shield electrodes 48 are electrically isolated from the pixel electrodes 41 and electrically connected to the hold capacitor lines 46.

The shield capacitances Csld1 and Csld2 exist between the pixel electrodes 41, 41 and the shield electrodes 48 arranged between the respective adjacent pixel electrodes 41, 41 on the hold capacitor lines 46. Therefore, the parasitic capacitances are less likely to appear between the pixel electrodes 41, 41. This reduces unwanted voltage variations at the pixel electrodes 41 and thus display uneveness due to the voltage variations are reduced. Therefore, high display quality can be achieved.

The configuration that uses the shield electrodes 48 for controlling the voltage variations of the pixel electrodes 41 is especially effective for the method of driving the liquid crystal panel 11 by inverting the voltage polarity for every block as described above. In this embodiment, the gate signal lines 45 are grouped into a plurality of blocks B1, B2, . . . , each block contains at least two gate signal lines 45. In each block B1, B2, . . . , the gate signal lines 45 on the even lines are scanned first and then those on the odd lines are scanned. Alternatively, the gate signal lines 45 on the odd lines are scanned first and then those on the even lines are scanned. The method is for driving the liquid crystal panel 11 by sending signals with different polarities during the driving of the TFTs 47 connected to the gate signal lines 45 on the even lines and during the driving of the TFTs 47 connected to the gate signal lines 45 on the odd lines.

With this method, the deterioration that may occur when DC voltages are applied to the liquid crystal components is less likely to occur. Moreover, flickering that may occur in large-size display devices due to voltage polarity alteration performed for each line can be reduced. On the other hand, the voltages with different polarity at the pixel electrodes 41 corresponding to the gate signal lines 45 on the odd lines may affect the voltages at the pixel electrodes 41 corresponding to the gate signal lines 45 on the even lines. The voltage variations may occur at the pixel electrodes 41 corresponding to the gate signal lines 45 on the even lines due to the parasitic capacitances between pixel electrodes 41, 41. The configuration including the shield electrodes 48 that can compensate for the parasitic capacitances is effective for reducing the voltage variations. As illustrated in FIG. 8, the shield capacitances Csld1 and Csld2 exit between the shield electrode 48 and the adjacent pixel electrodes 41 (41a, 41b) respectively. As a result, the parasitic capacitances between the pixel electrodes 41a and 41b can be compensated. This display uneveness and thus the high display quality can be achieved.

Dummy time is set for the first data signal after the voltage polarity of the data signals is altered. This improves the reaching rate (charging rate) that indicates how close the actual voltages reach the application voltages after the voltage polarity of the data signals is altered (i.e., inverted). Therefore, the signal waveform level is less likely to decrease and thus the display uneveness is further less likely to occur. In this embodiment, the dummy time is set by halting the LS signal. However, the first data signal after the voltage polarity is altered may be sent twice.

In this embodiment, the interlayer insulator 50 is formed between the gate signal lines 45 and the pixel electrodes 41, and the data signal lines 43 and the pixel electrodes 41, respectively. The interlayer insulator 50 includes the first interlayer insulator 51 made of inorganic material and the second interlayer insulator 52 made of organic material. The second interlayer insulator 52 has a larger thickness than the first interlayer insulator 51. The first interlayer insulator 51 and the second insulator 52 are layered in this order from the gate signal line 45 side or the data signal line 43 side.

The parasitic capacitances are less likely to appear between the gate signal lines 45 and the pixel electrodes 41 or between the data signal lines 43 and the pixel electrodes 41 because of these two insulators, that is, the first interlayer insulator 51 and the second interlayer insulator 52. Therefore, the voltage variations due to the influence of the gate signal line 45 or the data signal lie 43 are less likely to occur.

The parasitic capacitances are less likely to appear between the gate signal lines 45 and the pixel electrodes 41 or between the data signal lines 43 and the pixel electrodes 41 because of the double-layer insulator having a large thickness. On the other hand, the number of components that may produce electrical fields with the relevant pixel electrodes 41 decreases. Therefore, the parasitic capacitance is more likely to appear between the adjacent pixel electrodes 41, 41.

According to the configuration of this embodiment, the shield electrode 48 is provided while the electrical isolation structure is employed between the gate signal line 45 and the pixel electrode 41. With this configuration, the parasitic capacitance is less likely to appear between the adjacent pixel electrodes 41, 41. Therefore, the unwanted voltage variation is less likely to occur at each pixel even when the voltage polarity of the data signal is periodically altered. This enhances the effect of reducing the display uneveness. Because the second interlayer insulator 52 is made of organic material, designing thereof including thickness control for forming it thicker than the first interlayer insulator 51 is easy. Furthermore, the second interlayer insulator 52 can be easily formed.

In this embodiment, each shield electrode 48 formed on the corresponding hold capacitor line 46 is electrically connected to the hold capacitor line 46 via the shield electrode-hold capacitor line contact 54 formed between the adjacent pixel electrodes 41, 41.

With this configuration, an area for electrically connecting the shield electrode 48 to the hold capacitor line 46 is not required. For example, such an area for the connection does not need to be provided in the peripheral area NA around the active area AA in which the pixel electrodes 41 are arranged. This contributed to reducing the frame size.

Each shield electrode 48 is arranged so as to extend along the extending direction of the hold capacitor line 46 on which the shield electrode 48 is disposed. It extends from one of the ends of the active area AA to the other. Namely, the shield electrode 48 between the adjacent pixel electrodes 41, 41 is provided along the corresponding hold capacitor line 46 and electrically connected thereto.

This configuration provides a backup line structure in which the shield electrode 48 functions as a backup line for the hold capacitor line 46 even when the hold capacitor line 46 is broken.

The present invention is not limited to the first embodiment. For example, the following modifications may be included in the technical scope of the present invention. In the following modifications, the parts same as the above embodiment will be indicated by the same symbols and will not be illustrated or explained.

[First Modification]

The configuration illustrated in FIG. 9 may be employed as a modification of the electrical connection configuration between the shield electrode 48 and the hold capacitor line 46. FIG. 9 is a plan view schematically illustrating wiring patterns on the array board according to the first modification.

As illustrated in FIG. 9, an area of the array board 32A in which the pixel electrodes 41 are arranged in a matrix is an active area AA that can display images (inside the alternate long and two short dashes lines in FIG. 9). A frame-shape area outside the active area AA around the edges thereof is a peripheral area NA (outside the alternate long and two short dashes lines in FIG. 9) that cannot display images.

On the array board 32A, shield electrodes 48A are disposed on respective hold capacitor lines 46A between the respective adjacent pixel electrodes 41, 41. Each shield electrode 48A extends from one side of the peripheral areas NA to the opposite side of the peripheral area NA along the hold capacitor line 46A. Namely, the shield electrode 48A between the adjacent pixel electrodes 41, 41 is provided along the corresponding hold capacitor line 46A and electrically connected thereto.

Ends of the shield electrode 48A are located in the respective parts of the peripheral area NA, the parts located in the extending direction of the hold capacitor line 46A. Shield electrode-hold capacitor line contacts 54A are provided at the ends. Each shield electrode-hold capacitor line contact 54A has a shape that can make contact with the hold capacitor line 46A (i.e., electrically connectable). The shield electrode 48 and the hold capacitor line 46A are electrically connected to each other via the shield electrode-hold capacitor line contact 54A.

Each shield electrode 48A and the corresponding hold capacitor line 4A of this example are connected to each other via the shield electrode-hold capacitor line contacts 54A arranged in the respective parts of the peripheral areas NA. With this configuration, the balances between the shield capacitances Csld1 and Csld2 that exist between the shield electrode 48A and the pixel electrode 41 can be maintained. As a result, the parasitic capacitance is less likely to appear between the pixel electrodes 41, 41. This configuration is especially effective if the active area AA does not have enough space for a component or the like (e.g., a contact hole) for electrically connecting the shield electrode 48A to the hold capacitor line 46A. For example, it is effective if the active area AA does not have space for a contact hole.

[Second Modification]

The configuration illustrated in FIGS. 10 and 11 may be employed as a modification of the configuration of the shield electrodes 48. FIG. 10 is a plan view schematically illustrating wiring patterns on the array board according to the second modification. FIG. 11 is a magnified view of a relevant part of FIG. 10.

As illustrated in FIG. 10, shield electrodes 48B are disposed on the respective hold capacitor lines 46 between the respective pixel electrodes 41, 41 on an array board 32B. Moreover, the shield electrodes 48B that are adjacent to each other along the hold capacitor lines 46 are separated from each other. More specifically, each shield electrode 48B having a length substantially same as the short side of the pixel electrodes 41 is arranged between the adjacent pixel electrodes 41, 41 so as not to overlap the data signal line 43 that is substantially perpendicular to the hold capacitor line 46 when viewed in plan. Namely, the shield electrodes 48B are independently provided for the respective adjacent pixel electrodes 41 and the adjacent shield electrodes 48B, 48B are electrically isolated from each other.

Furthermore, each shield electrode 48B has a shield electrode-hold capacitor line contact 54B formed in a shape that can make contact with the hold capacitor line 46 (i.e., electrically connectable). Each shield electrode 48B is electrically connected to the corresponding hold capacitor line 46 via the shield electrode-hold capacitor line contact 54B.

With shield electrodes 48B of this example, the balances between the shield capacitances Csld1 and Csld2 between each shield electrode 48B and the pixel electrodes 41 are maintained. Therefore, the parasitic capacitance is less likely to appear between the adjacent pixel electrodes 41, 41.

Furthermore, the adjacent shield electrodes 48B, 48B are electrically isolated from each other, that is, the electrically independent shield electrode 48B is provided between each two of the pixel electrodes 41.

Each shield electrode 48B does not have a portion that overlap the data signal line 43 when viewed in plan. Therefore, an electrical field is less likely to be produced therebetween and thus an electrical load applied to the data signal line can be reduced. Therefore, a voltage variation (reduction in signal waveform level) is less likely to occur in the data signal fed to the data signal line 43.

[Third Modification]

The configuration illustrated in FIG. 12 may be employed as a modification of the configuration of the interlayer insulator 50. FIG. 12 is a magnified cross-sectional view illustrating a part of liquid crystal panel between pixels according to the third modification.

In the liquid crystal panel 11C of this example, each hold capacitor line 46 is formed on the glass substrate 32a of the array board 32 similar to the gate signal lines 45 (not shown). Moreover, the gate insulator 49 for electrically isolating the gate signal lines 45 from peripheral components is formed so as to cover the hold capacitor line 46 and the surface of the glass substrate 32a. Furthermore, an interlayer insulator 50C is formed so as to cover the gate insulator 49. The pixel electrodes 41 and the shield electrodes 48 are formed on the interlayer insulator 50C. The interlayer insulator 50C is an inorganic interlayer insulator made of inorganic material such as SiNx.

The interlayer insulator 50C has a thickness smaller than the interlayer insulator 50 in the first embodiment. Hold capacitances exist between the pixel electrodes 41 and the hold capacitor lines 46 via the interlayer insulators 50C and the gate insulators 49.

In the liquid crystal panel 11C of this example, the interlayer insulator 50C having a single layer with a relatively small thickness is provided between the pixel electrodes 41 and the hold capacitor lanes 46. Each shield electrode 48 has a shield electrode-hold capacitor line contact 54C formed in a shape such that the shield electrode 48 passes through the interlayer insulator 50C and the gate insulator 49, and contacts the hold capacitor line 46 (i.e., electrically connectable). The shield electrode 48 is electrically connected to the hold capacitor line 46 via the shield electrode-hold capacitor line contact 54C.

In the liquid crystal panel 11C of this example, the interlayer insulator 50 having a single layer with a relatively small thickness is formed between the electrodes 41 and the hold capacitor lines 46. Moreover, each shield electrode 48 passes through the interlayer insulator 50C and is electrically connected to the corresponding hold capacitor line 46 via the shield electrode-hold capacitor line contact 54. With this configuration, the shield capacitances Csld1 and Csld2 exist between the shield electrode 48 and the adjacent pixel electrodes 41 (41a, 41b). By connecting the shield electrode 48 to the hold capacitor line 46, the balances between the shield capacitances Csld1 and Csld2 can be maintained. Therefore, the parasitic capacitances are less likely to appear between the adjacent pixel electrodes 41, 41 and thus the voltage variations at the pixel electrodes 41 are less likely to occur.

[Fourth Modification]

A method of driving the liquid crystal display device expressed by a chart in FIG. 13 is provided as another example. FIG. 13 is a timing chart of data signals in the liquid crystal display device according to the fourth modification.

In FIG. 13, the first column contains the numbers of writable lines to which the signals is fed. The lines corresponding to the first to the fortieth gate signal lines 45 in the arrangement are shown in this chart. The voltage polarity of the data signals, the data number (No.) and the timing of the LS signals are shown in the upper part of the chart.

In this example, ten gate signal lines 45 from the first to the tenth lines indicated by the numbers in the first column of FIG. 13 is grouped into the first block K1. Another ten gate signal lines 45 from the eleventh to the twentieth lines are grouped into the second group K2. In the same manner, the 21^{st} to the 30^{th} lines are grouped into the third block K3, and the 31^{st} to the 40^{th} lines are grouped into the fourth block K4. Namely, every ten gate signal lines 45 are grouped into one block.

In this method, the gate signal lines 45 in the first block K1 are scanned according to the arrangement sequence starting from the first line. The data signals are fed to the data signal lines 43 while the TFTs 47 connected to the respective gate signal lines 45 in the first block K1 are driven. The data signals are the ones that correspond to the gate signal lines 45 in the first block K1. The data signals have a positive voltage polarity with respect to a reference voltage. Next, the gate signal lines 45 in the second block K2 are scanned according to the arrangement sequence starting from the eleventh line. The voltage polarity of the data signals corresponding to the gate signal lines 45 in the second block K2 is altered to negative (i.e., inverted), that is, it is altered to an opposite voltage polarity to the data signals for the first block K1 that is the adjacent block. The data signals are then fed to the respective data signal lines 43. Dummy time is set for the first data signal after the voltage polarity of the data signals is altered to negative. This improves the reaching rate (charging rate) that indicates how close the actual voltages reach the application voltages after the voltage polarity of the data signals is altered (i.e., inverted) from positive to negative.

Next, the gate signal lines 45 in the third block K3 are scanned according to the arrangement sequence starting from the twenty-first line. The voltage polarity of the data signals according to the gate signal lines 45 in the third block K3 is altered to positive (i.e., inverted), that is, it is altered to an opposite voltage polarity to the data signals for the second block K2 that is the adjacent block. Dummy time is set for the first data signal after the voltage polarity of the data signals is altered to positive. This improves the reaching rate (charging rate) that indicates how close the actual voltages reach the application voltages after the voltage polarity of the data signals is altered (i.e., inverted) from negative to positive. The polarity of the data signals is altered for every block and the data signals are fed in the same manner as described above. Moreover, the dummy time is also set for the first data signal after the voltage polarity of the data signals is altered, that is, prior to the scanning of each block.

By employing such a method of driving the liquid crystal display device, the deterioration of the liquid crystal components that may occur when the DC voltages are applied thereto can be reduced. Because the polarities are the same within one block, the display uneveness in that block is less likely to occur. The voltage polarity of the data signals in one block is different from that in the adjacent blocks. This may cause voltage variations at the pixel electrodes 41 to which the data signals are fed earlier than the next because the voltage polarity of the pixel electrodes 41 in the next block is different. The voltage variations at the pixel electrodes 41 occur due to the parasitic capacitances exist between the pixel electrodes 41, 41. By employing the configuration in which the shield electrodes 48 are provided between the pixel electrodes 41, 41, the parasitic capacitances are less likely to appear. This is effective for reducing the voltage variations at the pixel electrodes 41. As a result, the display uneveness that may be caused by the voltage variations is less likely to occur in the liquid crystal display device 10 and thus high display quality can be achieved.

### Second Embodiment

The second embodiment of the present invention will be explained with reference to FIGS. 14 to 17. The difference between the first embodiment and this embodiment is that the shield electrodes are disposed on the gate signal lines but other configurations are the same. The same parts as the first embodiment will be indicated by the same symbols and will not be explained.

FIG. 14 is a plan view schematically illustrating wiring patterns on an array board included in the liquid crystal display device according to is embodiment. FIG. 15 is a magnified plan view of relative part of the array board in FIG. 14.

As illustrated in FIGS. 14 and 15, an array board 60 includes signal lines arranged in a grid and rectangular pixel electrodes 61 arranged in a matrix such that each pixel electrode 61 is surrounded by the signal lines. The signal lines include the data signal lines 43 that extend in the column direction (the vertical direction in FIGS. 14 and 15) on the array board 60 and connected to the data driver 42. The signal lines also include gate signal lines 63 that extend in the row direction (the horizontal direction in FIGS. 14 and 15) and connected to a gate driver 62 and the hold capacitor lines 64. The gate signal lines 63 and the hold capacitor lines 64 are alternately arranged. Hold capacitances exist between the pixel electrodes 61 and the hold capacitor lines 64. In this embodiment, each gate signal line 63 is arranged between the adjacent pixel electrodes 61, 61, and each hold capacitor line 64 is arranged on the corresponding pixel electrode 61 so as to overlap a centerline area of the pixel electrode 61. Furthermore, the TFTs 47 are arranged so as to overlap the respective gate signal lines 63 and connected to the respective pixel electrodes 61. In FIG. 15, one pixel electrode 61 is one pixel unit of the liquid crystal display device 10. In FIG. 14, the area in which the pixel electrodes are arranged in a matrix is the active area AA that can display images (the area inside alternate long and two short dashes lines in FIG. 14). A frame-shape area outside the active area AA around the edges thereof is the peripheral areas NA (outside the alternate long and two short dashes lines in FIG. 14) that cannot display images.

Furthermore, shield electrodes 65 are arranged in areas that overlap the respective gate signal lines 63. Each shield electrode 65 is arranged between the adjacent pixel electrodes 61, 61 so as to extend from one side of the peripheral area NA to the opposite side of the peripheral area NA along the corresponding gate signal line 63. Namely, each shield electrode 65 between the adjacent pixel electrodes 61, 61 is provided along the corresponding gate signal line 63 and electrically connected thereto.

The layered structure of the pixel electrodes 61, the gate signal lines 63 and the shield electrodes 65 will be explained in detail with reference to FIG. 16. FIG. 16 is a magnified cross-sectional view illustrating a part of the liquid crystal panel around the center of screen.

The gate signal lines 63 are formed on the glass substrate 32a of the array board 60 and the gate insulator 49 is formed so as to cover the gate signal lines 63 and the surface of the glass substrate. The gate insulator 49 is provided for electrically isolating the gate signal lines 63 from peripheral components. Moreover, the interlayer insulator 50 having a two-layered structure is formed so as to cover the gate insulator 49. The pixel electrodes 61 and the shield electrodes 65 are disposed on the interlayer insulator 50.

Each shield electrode 65 has a shield electrode-gate signal line contact 66 formed in a shape such that the shield electrode 65 can passes through the second interlayer insulator 52, the first insulator 51 and the gate insulator 49, and then contacts the gate signal line 63 (i.e., electrically connectable). The shield electrodes 65 are electrically connected to the respective gate signal lines via the shield electrode-gate signal line contacts 66.

The method of driving the liquid crystal panel 11 of this embodiment uses the same method as the first embodiment. Operation of the liquid crystal display device 10 by the method will be explained with reference to an equivalent circuit in FIG. 17.

In FIG. 17, a pixel electrode 61a receives the data signal having the positive voltage polarity corresponding to the gate signal line 63 on an odd line. A pixel electrode 61b receives the data signal having the negative voltage polarity corresponding to the gate signal line 63 on an even line. A liquid crystal capacitance Clc1 exists between the pixel electrode 61a and the common electrode 36 that faces the pixel electrode 61a via the liquid crystal layer 33. A liquid crystal capacitance Clc2 exists between the pixel electrode 61b that is adjacent to the pixel electrode 61a. and the common electrode 35. A small parasitic capacitance Cgd1 exists between the pixel electrode 61a and the gate signal line 63. Moreover, a small parasitic capacitance Cgd2 exists between the pixel electrode 61b and the gate signal line 63. By providing the shield electrode 65 connected to the gate signal line 63 between the adjacent pixel electrodes 61a and 61b, the shield capacitance Csld1 appears between the pixel electrode 61a and the shield electrode 65, and the shield capacitance Csld2 appears between the pixel electrode 61b and the shield electrode 65.

According to the above method, the pixel electrode 61a receives the data signal with the positive voltage polarity and then the pixel electrode 61b receives the data signal with the negative voltage polarity after the TFT 47 connected to the pixel electrode 61a is turned off. If the shield electrode 65 is not provided between the pixel electrodes 61a and 61b, the parasitic capacitance appears between the pixel electrodes 61a and 61b. As a result, the pixel electrodes 61a and 61b may electrically influence each other. Specifically, the positive voltage at the pixel electrode 61a to which the TFT 47 that is turned off first is connected decreases due to the negative voltage applied to the pixel electrode 61b.

In the configuration of this embodiment, the shield electrode 65 is provided between the pixel electrodes 61a and 61b. Therefore, the shield capacitance Csld1 exists between the pixel electrode 61a and the shield electrode 65, and the shield capacitance Csld2 exists between the pixel electrode 61b and the shield electrode 65. Moreover, the shield electrode 65 is electrically connected to the gate signal line 63 and thus the balances of the shield capacitances Csld1 and Csld2 can be maintained. Therefore, the shield capacitances Csld1 and Csld2 remain stable and the parasitic capacitance is less likely to appear between the pixel electrodes 61a and 61b.

According to the liquid crystal display device 10 of this embodiment, the gate signal lines 63 are provided between the respective adjacent pixel electrodes 61, 61 that extend along the data signal lines 43. Each shield electrode 65 is arranged on the corresponding gate signal line 63 between the adjacent pixel electrodes 61, 61. Moreover, the shield electrode 65 is electrically isolated from the pixel electrode 61 and electrically connected to the gate signal line 63.

With this configuration, the shield capacitances Csld1 and Csld2 exist between the shield electrode 65 on the gate signal line 63, which is provided between the adjacent pixel electrodes 61, 61, and the respective pixel electrodes 61. Therefore the parasitic capacitance is less likely to appear between the pixel electrodes 61, 61 and thus the unwanted voltage variations at the pixel electrodes 61 are less likely to occur. As a result, the display uneveness due to the voltage variations is less likely to occur and high display quality can be achieved.

In this embodiment, each shield electrode 65 on the corresponding gate signal line 63 is electrically connected o the gate signal line 63 via the shield electrode-gate signal line contacts 66 provided between the adjacent pixel electrodes 61, 61.

With this configuration, an area for electrical connecting the shield electrode 65 to the gate signal line 63 is not required in the peripheral area NA around the active area AA in which the pixel electrodes 61 are arranged. This contributed to reducing the frame size.

In this embodiment, each shield electrode 65 extends from one side of the peripheral area NA to the opposite side of the peripheral area NA along the gate signal line 63 on which the shield electrode 65 is arranged. Namely, the shield electrode 65 between the adjacent pixel electrodes 61, 61 is provided along the gate signal line 63 and electrically connected thereto.

This configuration provides a backup line structure in which the shield electrode 65 functions as a backup line for the gate signal line 63 even when the gate signal line 63 is broken.

The present invention is not limited to the second embodiment. For example, the following modifications may be included in the technical scope of the present invention. In the following modifications, the parts same as the above embodiment will be indicated by the same symbols and will not be illustrated or explained.

[Fifth Modification]

The configuration illustrated in FIG. 18 may be employed as a modification of the configuration of the electrical connection between the shield electrodes 65 and the gate signal lines 63. FIG. 18 is a plan view schematically illustrating wiring patterns on an array board according to the fifth modification.

As illustrated in FIG. 18, an area of an array board 60A in which the pixel electrodes 61 are arranged in a matrix is an active area AA that can display images (an area inside the alternate long and two short dashes lines in FIG. 18). A frame-shape area outside the active area AA around the edges thereof is a peripheral area NA (outside the alternate long and two short dashes lines in FIG. 18) that cannot display images.

On the array board 60A, shield electrodes 65A are arranged on the respective gate signal lines 63 between the respective adjacent pixel electrodes 61, 61. Each shield electrode 65A extends from one side of the peripheral area NA to the opposite side of the peripheral area NA along the gate signal line 63. Namely, the shield electrode 65A between the adjacent pixel electrodes 61, 61 is provided along the corresponding gate signal line 63 and electrically connected thereto.

Ends of the shield electrode 65A are located in the respective parts of the peripheral area NA, the parts located in the extending direction of the gate signal line 63. Shield electrode-gate signal line contacts 66A are provided at the ends. Each shield electrode-gate signal line contact 66A has a shape that can make contact with the gate signal line 66A (i.e., electrically connectable). The shield electrode 65 and gate signal line 66A are electrically connected to each other via the shield electrode-gate signal line contact 66A.

Each shield electrode 65A is electrically connected to the gate signal line 63 via the shield electrode-gate signal line contacts 66A provided in the respective parts of the peripheral area NA. Therefore, the balances between the shield capacitances Csld1 and Csld2 that exist between the shield electrodes 65A and the pixel electrodes 61 can be maintained. As a result, the parasitic capacitance is less likely to appear between the pixel electrodes 61, 61.

[Sixth Modification]

The configuration illustrated in FIGS. 19 and 20 may be employed as a modification of the configuration of the shield electrodes 65. FIG. 19 is a plan view schematically illustrating wiring patterns on an array board according to the sixth modification. FIG. 20 is a magnified plan view illustrating a relevant part of FIG. 19.

As illustrated in FIG. 19, shield electrodes 65B are arranged on the respective gate signal lines 63 between the respective adjacent pixel electrodes 61, 61 and the adjacent shield electrodes 65B, 65b are separated from each other. More specifically, as illustrated in FIG. 20, each shield electrode 65B having a length substantially same as the short side of the pixel electrodes 61 is arranged between the adjacent pixel electrodes 61, 61 so as not to overlap the data signal line 43 that is substantially perpendicular to the gate signal line 63 when viewed in plan. Namely, the shield electrodes 65B are independently provided for the respective adjacent pixel electrodes 61 and the adjacent shield electrodes 65B, 65B are electrically isolated from each other.

Each shield electrode 65B has a shield electrode-gate signal line contact 66B formed in a shape such that the shield electrode 65B can contact the gate signal line 63 (i.e., electrically connectable). The shield electrode 65B and the gate signal line 63 are electrically connected to each other via the shield electrode-gate signal line contact 66B.

With the shield electrodes 65B in this example, the balances between the shield capacitances Csld1 and Csld2 that exist between the shield electrodes 65B and the pixel electrodes 61 can be maintained. Therefore, the parasitic capacitances are less likely to appear between the adjacent pixel electrodes 61, 61.

Furthermore, the adjacent shield electrodes 65E, 65B are electrically isolated from each other. The shield electrodes 65B that are electrically independent from each other are arranged between the respective adjacent pixel electrodes 61. Namely, a component or the like (e.g., a contact hole) for electrically connecting the shield electrodes 65B is not required. This contributes to a cost reduction.

[Seventh Modification]

As illustrated in FIG. 21, a single-layer interlayer insulator 50C may be provided between each shield electrode 65C and the corresponding gate signal line 63 when the shield electrodes 65C and the gate signal lines 63 are electrically connected to each other. In this case, each shield electrode 65C should have a shield electrode-gate signal line contact 660 having a shape such that the shield electrode 65C can pass through the interlayer insulator 50 and the gate insulator 49 and then contact the gate signal line (i.e., electrically connectable). The shield electrode 650 and the gate signal line 63 are electrically connected to each other via the shield electrode-gate signal line contact 660. In this example, the interlayer insulator 50C is an inorganic interlayer insulator made of inorganic material such as SiNx.

[Eight Modification]

As illustrated in FIG. 22, an array board GOD on which the hold capacitor lines 64 are not provided may be used when shield electrodes 65D and gate signal lines 63D are electrically connected to each other. In this case, each gate signal line 63D functions as a hold capacitor line such as the hold capacitor line 64 so that a hold capacitance appears between the gate signal line 63D and the pixel electrode 61.

### Third Embodiment

The third embodiment of this invention will be explained with reference to FIGS. 23 to 26. The difference between this embodiment and the first and the second embodiments is that the shield electrodes are electrically connected to the common electrode. Other configurations are the same as the above embodiments. The same parts as the above embodiments will be indicated by the same symbols and will not be explained.

FIG. 23 is a plan view schematically illustrating wiring patterns on an array board included in the liquid crystal display device according to this embodiment. FIG. 24 is a magnified cross-sectional view illustrating a central part of screen of the liquid crystal panel. FIG. 25 is a magnified cross-sectional view illustrating an end part of screen of the liquid crystal panel.

As illustrated in FIG. 23, an array board 70 includes rectangular pixel electrodes 41 arranged in a matrix and signal lines arranged in a grid such that each signal line is located between the adjacent pixel electrodes 41, 41. More specifically, the data signal lines 43 extend in the column direction (the vertical direction in FIG. 23) on the array board 70 and connected to the data driver 42. Moreover, the gate signal lines 45 and the hold capacitor lines 46 are arranged alternately in the extending direction of the data signal lines 43 between the adjacent pixel electrodes 41. They extend along the row direction (the horizontal direction in FIG. 23). The gate signal lines 45 are connected to the gate driver 44. Hold capacitances exist between the pixel electrodes 41 and the hold capacitor lines 46. Furthermore, the TFTs 47 are arranged so as to overlap the respective gate signal lines 45 and connected to the respective pixel electrodes 41. The TFTs 47 are arranged such that the ones adjacent to each other in the column direction (the vertical direction in FIG. 23) so as to face each other. In FIG. 22, the area in which the pixel electrodes are arranged in a matrix is the active area AA that can display images (the area inside alternate long and two short dashes lines in FIG. 23). A frame-shape area outside the active area AA around the edges thereof is the peripheral area NA (outside the alternate long and two short dashes lines in FIG. 23) that cannot display images.

Furthermore, shield electrodes 71 are arranged between the adjacent pixel electrodes 41, 41. They extend so as to overlap the respective hold capacitor lines 46. Each shield electrode 71 extends from one side of the peripheral area NA to the opposite side of the peripheral area NA along the hold capacitor line 46. Namely, each shield electrode 71 between the adjacent pixel electrodes 41, 41 is provided along the corresponding hold capacitor line 46 and electrically connected thereto.

As illustrated in FIG. 24, each shield electrode 71 in the array board 70 is electrically isolated from the hold capacitor line 46 and the gate signal line 45 with the gate insulator 49, the first interlayer insulator 51 and the second interlayer insulator 52.

Each shield electrode 71 has shield electrode-common electrode contacts 72 at ends thereof in the respective parts of the peripheral area NA. The shield electrode-common electrode contacts 72 are made of conductive paste, and connected to the common electrode 73 provided on the CF substrate 31 that faces the array board 70. Namely, the shield electrode 71 and the common electrode 73 are electrically connected to each other via the contacts 72. Although the shield electrode 71 and the common electrode 73 are electrically connected to each other via the shield electrode-common electrode contacts 72 in this embodiment, the shield electrode 71 may be connected to a conductive member for making potentials at the common electrode 73 and the pixel electrodes 41 to a common potential. Such a conductive member is used conventionally.

The same method of driving the liquid crystal panel 11 used in the first embodiment is used in this embodiment. Operation of the liquid display device 10 of this embodiment using the method will be explained with reference to an equivalent circuit illustrated in FIG. 26.

In FIG. 26, the pixel electrode 41a receives a data signal having a positive voltage polarity corresponding the gate signal line 45 on the odd line. The pixel electrode 41b receives a data signal having a negative voltage polarity corresponding the gate signal line 45 on the even line. The liquid crystal capacitance Clc1 exists between the pixel electrode 41a and the common electrode 73 that faces the pixel electrode 41a via the liquid crystal layer 33. The liquid crystal capacitance Clc2 exits between the pixel electrode 41b that is adjacent to the pixel electrode 41a and the common electrode 73. The hold capacitances Ccx1 and Ccs2 exist between the pixel electrodes 41a and 41b and the hold capacitor line 46, respectively. Furthermore, the shield capacitances Csld1 and Csld2 appear between the pixel electrodes 41a and 41b and the shield electrodes 65, respectively, when the shield electrode 71 connected to the common electrode 73 is provided between the adjacent pixel electrodes 41a and 41b.

With the above method, the data signal having a positive voltage polarity is fed to the pixel electrode 41a and the data signal having a negative voltage polarity is fed to the pixel electrode 41b after the TFT 47 connected to the pixel electrode 41a is turned off. If the shield electrode 71 is not connected between the pixel electrodes 41a and 41b, a parasitic capacitance appears between the pixel electrodes 41a. and 41b and the pixel electrodes 41a and 41b may electrically influence each other through the parasitic capacitance. Specifically, the positive voltage at the pixel electrode 41a to which the TFT 47 that is turned off first is connected decreases due to the negative voltage applied to the pixel electrode 41b.

By connecting the shield electrode 71 between the pixel electrodes 41a and 41b, the shield capacitances Csld1 and Csld2 appear between the pixel electrode 41a and the shield electrode 71 and between the pixel electrode 41b and the shield electrode 71, respectively. Furthermore, the shield electrode 65 is electrically connected to the common electrode 73 and thus the balances between the shield capacitances Csld1 and Csld2 are maintained. Therefore, the shield capacitances Csld1 and Csld2 remain stable and the parasitic capacitance is less likely to appear between the pixel electrodes 41a and 41b.

According to the liquid crystal display device 10 of this embodiment, the gate signal lines 45 and the hold capacitor lines 46 are arranged between the respective pixel electrodes 41, 41 that are adjacent in the extending direction of the data signal lines 43. The shield electrodes 71 are provided on the respective hold capacitor lines 46 between the respective adjacent pixel electrodes 41 (41a and 41b). Moreover, the shield electrodes 71 are electrically isolated from the pixel electrodes 41 and electrically connected to the common electrode 73 that faces the pixel electrodes 41.

With this configuration, the shield capacitances Csld1 and Csld2 exist between the shield electrode 71 between the adjacent pixel electrodes 41, 41 and the pixel electrodes 41, respectively. Therefore, the parasitic capacitance is less likely to appear between the pixel electrodes 41, 41. Therefore, the unwanted voltage variations do not occur at the pixel electrodes 41. As a result, the display uneveness due to the voltage variation is less likely to occur and high display quality can be achieved.

Because the shield electrodes 71 and the common electrode 73 are provided on different substrates 70 and 31 that face each other via the liquid crystal layer 33, respectively, the configuration in which the shield electrodes 71 and the common electrode 73 are electrically connected to each other in the respective parts of the peripheral area NA outside the active area AA is especially preferable.

In this embodiment, the shield electrodes 71 that are electrically connected to the common electrode 73 are provided on the respective hold capacitor lines 46. However, as illustrated in FIG. 27, an array board 70A on which the shield electrodes 71A are provided on the gate signal lines 45 may be used according to arrangement of the pixel electrodes 41.

### Fourth Embodiment

The fourth embodiment of the present invention will be explained with reference to FIGS. 28 and 29. The differences between this embodiment and the first to the third embodiments are that shield electrodes are provided on gate signal lines and electrically connected to hold capacitor lines. Other configurations are the same as the above embodiments. The parts same as the above embodiments will be indicated by the same symbols and will not be explained.

FIG. 28 is a plan view schematically illustrating wiring patterns on an array board included in the liquid crystal display device of this embodiment. FIG. 29 is a magnified plan view of a relevant part of the array board in FIG. 28.

As illustrated in FIGS. 28 and 29, an array board 80 includes signal lines arranged in a grid and rectangular pixel electrodes 61 arranged in a matrix such that each pixel electrode 61 is surrounded by the signal lines. The signal lines include the data signal lines 43 that extend in the column direction (the vertical direction in FIGS. 28 and 29) on the array board 80 and connected to the data driver 42. The signal lines also include gate signal lines 63 that extend in the row direction (the horizontal direction in FIGS. 28 and 29) and connected to a gate driver 62 and the hold capacitor lines 64. The gate signal lines 63 and the hold capacitor lines 64 are alternately arranged. In this embodiment, each gate signal line 63 is arranged between the adjacent pixel electrodes 61, 61, and each hold capacitor line 64 is arranged on the corresponding pixel electrode 61 so as to overlap a centerline area of the pixel electrode 61. Furthermore, the TFTs 47 are arranged so as to overlap the respective gate signal lines 63 and connected to the respective pixel electrodes 61. In FIG. 29, one pixel electrode 61 is one pixel unit of the liquid crystal display device 10. In FIG. 28, the area in which the pixel electrodes are arranged in a matrix is the active area AA that can display images (the area inside alternate long and two short dashes lines in FIG. 28). A frame-shape area outside the active area AA around the edges thereof is the peripheral area NA (outside the alternate long and two short dashes lines in FIG. 28) that cannot display images.

Shield electrodes 81 are provided so as to overlap the respective gate signal lines 63 between the respective adjacent pixel electrodes 61, 61. Each shield electrode 81 extends from one side of the peripheral area NA to the opposite side of the peripheral area NA along the gate signal line 63. Namely, the shield electrode 81 between the respective adjacent pixel electrodes 61, 61 is provided along the corresponding gate signal line 63 and electrically connected thereto.

As illustrated in FIG. 28, ends of each shield electrode 81 extend in a direction substantially perpendicular to the extending direction thereof in the peripheral areas NA. The ends are electrically connected to ends of the hold capacitor line 64 adjacent to the gate signal line 63 on which the shield electrode is provided via contacts 82. Namely, each hold capacitor line 64 and the adjacent shield electrode 81 are electrically connected to each other in the peripheral area NA. In this embodiment, each shield electrode 81 extends in the direction substantially perpendicular to the extending direction thereof. However, the ends of each shield electrode 81 may be electrically connected to the ends of the corresponding hold capacitor line 64 with conductive material.

With this configuration, that is, with the shield electrode 81 provided between the adjacent pixel electrodes 61, 61, the shield capacitances Csld1 and Csld2 exist between the respective pixel electrodes 61, 61 and the shield electrode 81. Therefore, the parasitic capacitance is less likely to appear between the pixel electrodes 61, 61 and thus unwanted voltage variations are less likely to occur at the pixel electrodes 61.

Furthermore, the shield electrodes 81 are arranged on the respective gate signal lines 64. Therefore, control capacitances are less likely to appear between the gate signal lines 64 and the pixel electrodes 61 and thus unwanted voltage variations are less likely to occur at the pixel electrodes 61. As a result, display uneveness due to the voltage variations is less likely to occur and thus high display quality can be achieved. Moreover, the shield electrodes 81 can reduce alignment disorder of the liquid crystals due to electric fields generated by the gate signal lines 64. Therefore, residual images on display, contrast reduction or light-transmission reduction due to the electrical fields generated by the gate signal lines is less likely to occur, and high display quality can be achieved.

### Other Embodiment

The present invention is not limited to the embodiments explained above with reference to the figures. For example, the following embodiments may be included in the technical scope of the present invention.

(1) In the above embodiments, the second interlayer insulator 52 is made of organic material. However, an insulator made of spin-on glass (SOG) such as silica may be used.

(2) In the above embodiments, the liquid crystal panel 11 is used for a display panel. However, the embodiments of the present invention can be applied to display devices using other kinds of display panels (e.g., an EL panel).

1. A display device comprising:
a plurality of gate signal lines to which gate signals are fed;
a plurality of data signal lines extending in a direction that crosses the gate signal lines and to which data signal are fed;
switching components arranged around intersections of the gate signal lines and the data signal lines;
pixel electrodes connected to the switching components;
hold capacitor lines configured such that hold capacitances appear between the hold capacitor lines and the respective pixel electrodes;
a common electrode arranged so as to face the pixel electrodes and configured such that a voltage can be applied across the pixel electrodes and the common electrode; and
conductive parts provided between the pixel electrodes adjacent to each other, the conductive parts being electrically isolated from the pixel electrodes and electrically connected to at least one of the gate signal lines, the hold capacitor lines and the common electrode.

2. The display device according to claim 1, wherein:
the gate signal lines are grouped into a plurality of blocks, each of which includes at least two gate signal lines; and
voltage polarities of the data signals with respect to a reference voltage in the adjacent blocks differ from one another.

3. The display device according to claim 1, wherein:
the gate signal lines are grouped into a plurality of blocks, each of which includes at least two gate signal lines;
the gate signal lines in each block are configured to be scanned in any one of manners that the gate signal lines on odd lines are scanned after the gate signal lines on even lines are scanned and the gate signal lines on even lines are scanned after the gate signal lines on odd lines are scanned; and
a voltage polarity of the data signals fed to the gate signal lines on the even lines with respect to a reference voltage differs from a voltage polarity of the data signals fed to the gate signal lines on the odd lines with respect to the reference voltage.

4. The display device according to claim 1, further comprising an interlayer insulator between the gate signal lines and the pixel electrodes, and between the data signal lines and the pixel electrodes, the interlayer insulator being provided to electrically isolate the pixel electrodes from the gate signal lines and the data signal lines,
wherein the interlayer insulator includes a first interlayer insulator and a second interlayer insulator layered in this order from a side on which the gate signal line and the data signal lines are located, the second interlayer insulator having a larger thickness than the first interlayer insulator.

5. The display device according to claim 4, wherein:
the first interlayer insulator is made of inorganic material; and
the second interlayer insulator is made of organic material.

6. The display device according to claim 1, wherein the conductive parts are electrically connected to any of the gate signal lines and the hold capacitor lines between the pixel electrodes.

7. The display device according to claim 1, wherein:
the conductive parts are arranged between the respective pixel electrodes so as to overlap any of the gate signal lines and the hold capacitor lines; and
the conductive parts that are adjacent to each other in extending direction of the gate signal lines or the hold capacitor lines are electrically connected to each other.

8. The display device according to claim 1, further comprising an active area in which the pixel electrodes are arranged and a peripheral area located outside the active area,
wherein the conductive parts are electrically connected to at least one of the gate signal lines, the hold capacitor lines and the common electrode.

9. The display device according to claim 1, wherein:
the conductive parts are arranged between the respective pixel electrodes; and
the adjacent conductive parts are electrically isolated from each other.

10. The display device according to claim 9, wherein the conductive parts do not have portions that overlap the data signal lines in plan view.

11. The display device according to claim 1, wherein the display panel is a liquid crystal panel including liquid crystals sealed between a pair of substrates.

12. A television receiver comprising the display device according to claim 1.
